(19) United States
(12) Patent Application Publication
(10) Pub. No.: US 2026/0003182 A1
(43) Pub. Date: Jan. 1, 2026

(54) LIGHT SCANNING APPARATUS AND IMAGE FORMING APPARATUS INCLUDING THE SAME

(71) Applicant: CANON KABUSHIKI KAISHA, Tokyo (JP)

(72) Inventors: Ryota SATO, Tochigi (JP); Hiroyuki FUKUHARA, Shizuoka (JP)

(21) Appl. No.: 19/245,746

(22) Filed: Jun. 23, 2025

(30) Foreign Application Priority Data
Jun. 28, 2024 (JP) 2024-104569

(51) Int. Cl. G02B 26/12; B41J 2/44; B41J 2/47; G02B 19/00; G03G 15/04; G03G 15/041

(52) U.S. Cl. CPC G02B 26/125; B41J 2/44; B41J 2/471; G02B 19/0004; G03G 15/04036; G03G 15/0415

(57) ABSTRACT

A light scanning apparatus according to the present disclosure includes a deflecting unit deflecting a light flux from a light source to scan a surface in a main scanning direction, a first optical system guiding the light flux deflected by the deflecting unit to the surface to be scanned at a first timing, and a second optical system guiding the light flux deflected by the deflecting unit to a light receiving element at a second timing different from the first timing, in which the second optical system includes a first optical element which has a diffracting surface and condenses the light flux deflected by the deflecting unit at the second timing in a main scanning cross section, and a value of a diffractive power of the first optical element is equal to or larger than a value of a refractive power thereof in the main scanning cross section.

### BACKGROUND

### Field of the Technology

The present disclosure is related to a light scanning apparatus, and to a light scanning apparatus suitably used in an image forming apparatus such as a laser beam printer (LBP), a digital copying machine, and a multi-function printer.

### Description of the Related Art

Conventionally, in a light scanning apparatus, synchronization detection is performed in which a light flux deflected by a deflecting unit is received by a synchronous detection unit (light receiving unit) to determine a writing start timing on a surface to be scanned.

On the other hand, when environmental temperature changes in such synchronization detection, an optical performance of a synchronous detection optical system for guiding the light flux to the synchronous detection unit changes, thereby, a light receiving position of the light flux in the synchronous detection unit may change to change the writing start timing, for example.

Japanese Patent Laid-open No. 2001-166232 discloses a light scanning apparatus in which a diffracting surface is provided in a synchronous detection optical system to suppress a change in optical performance of the synchronous detection optical system due to a change in environmental temperature.

### SUMMARY

A light scanning apparatus according to the embodiments includes a deflecting unit configured to deflect a light flux from a light source to scan a surface in a main scanning direction, a first optical system configured to guide the light flux deflected by the deflecting unit to the surface to be scanned at a first timing, and a second optical system configured to guide the light flux deflected by the deflecting unit to a light receiving element at a second timing different from the first timing, in which the second optical system includes a first optical element which has a diffracting surface and is configured to condense the light flux deflected by the deflecting unit at the second timing in a main scanning cross section, and a value of a diffractive power of the first optical element is equal to or larger than a value of a refractive power of the first optical element in the main scanning cross section.

Features of the present disclosure will become apparent from the following description of embodiments with reference to the attached drawings. The following description of embodiments are described by way of example.

### BRIEF DESCRIPTION OF THE DRAWINGS

FIG. 1A is a main scanning cross sectional view of a light scanning apparatus according to a first embodiment of the present invention.

FIG. 1B is a partial sub-scanning cross sectional view of the light scanning apparatus according to the first embodiment.

FIG. 1C is a partial sub-scanning cross sectional view of the light scanning apparatus according to the first embodiment.

FIG. 2A is a partial main scanning cross sectional view of the light scanning apparatus according to the first embodiment.

FIG. 2B is a graph showing a relationship between a rotation angle of a deflecting unit and a light amount of light received by a synchronous detection unit in the light scanning apparatus according to the first embodiment.

FIG. 3A is a partial main scanning cross sectional view of the light scanning apparatus according to the first embodiment.

FIG. 3B is a partial main scanning cross sectional view of the light scanning apparatus according to the first embodiment.

FIG. 4A is a graph showing a positional dependence of a main scanning LSF spot diameter in a light scanning apparatus according to a comparative example.

FIG. 4B is a graph showing a positional dependence of the main scanning LSF spot diameter in the light scanning apparatus according to the first embodiment.

FIG. 5A is a front view of a synchronous detection optical element included in the light scanning apparatus according to the first embodiment.

FIG. 5B is a top view of the synchronous detection optical element included in the light scanning apparatus according to the first embodiment.

FIG. 6A is a main scanning cross sectional view of a light scanning apparatus according to a second embodiment of the present invention.

FIG. 6B is a partial sub-scanning cross sectional view of the light scanning apparatus according to the second embodiment.

FIG. 6C is a partial sub-scanning cross sectional view of the light scanning apparatus according to the second embodiment.

FIG. 7A is a front view of a synchronous detection optical element included in the light scanning apparatus according to the second embodiment.

FIG. 7B is a top view of the synchronous detection optical element included in the light scanning apparatus according to the second embodiment.

FIG. 8 is a graph showing an image height dependence of a scanning speed ratio in the light scanning apparatus according to the second embodiment.

FIG. 9 is a graph showing a positional dependence of the main scanning LSF spot diameter in the light scanning apparatus according to the second embodiment.

FIG. 10A is a main scanning cross sectional view of a light scanning apparatus according to a third embodiment of the present invention.

FIG. 10B is a partial sub-scanning cross sectional view of the light scanning apparatus according to the third embodiment.

FIG. 10C is a partial sub-scanning cross sectional view of the light scanning apparatus according to the third embodiment.

FIG. 11 is a graph showing a positional dependence of the main scanning LSF spot diameter in the light scanning apparatus according to the third embodiment.

FIG. 12 is a sub-scanning cross sectional view of a main part of an image forming apparatus according to the present embodiments.

### DESCRIPTION OF THE EMBODIMENTS

Hereinafter, a light scanning apparatus according to the present embodiments is described in detail with reference to the accompanying drawings. Note that drawings described below may be drawn on a scale different from an actual scale in order to facilitate understanding of the present disclosure.

In the following description, a main scanning direction is a direction perpendicular to a rotation axis of a deflecting unit and an optical axis of an optical system (a direction in which a surface to be scanned is scanned by the deflecting unit), and a sub-scanning direction is a direction parallel to the rotation axis of the deflecting unit.

Further, a main scanning cross section is a cross section perpendicular to the sub-scanning direction, and a sub-scanning cross section is a cross section perpendicular to the main scanning direction.

That is, a direction parallel to an optical axis of an optical system is a direction perpendicular to the rotation axis of the deflecting unit and the main scanning direction.

Furthermore, the main scanning direction is defined as a Y direction, the sub-scanning direction is defined as a Z direction, and a direction parallel to an optical axis of an imaging optical system 85 is defined as an X direction. A direction parallel to an optical axis of a synchronous detection optical system 95 is defined as an XBD direction.

### First Embodiment

Conventionally, a light scanning apparatus is provided with a synchronous detection optical system and a synchronous detection unit for acquiring a synchronization detection signal for aligning a writing start position (irradiation start timing) when a light flux deflected by a deflecting unit optically scans a surface to be scanned in a main scanning direction.

In order to suppress a decrease in synchronization detection accuracy due to a change in temperature of an optical element provided in the synchronous detection optical system or the temperature of an environment around the synchronous detection optical system, a light scanning apparatus in which a diffracting optical element is provided in the synchronous detection optical system is proposed.

For example, a light scanning apparatus is proposed in which a blazed diffracting surface is provided in the synchronous detection optical system to reduce a shift of a condensed position on a light receiving surface of the synchronous detection unit due to an increase in temperature.

On the other hand, in the proposed light scanning apparatus, the shift of the condensed position in the main scanning direction due to the temperature increase is reduced, but the shift of the condensed position in the direction parallel to the optical axis of the synchronous detection optical system due to the temperature rise is not considered.

Further, for example, a light scanning apparatus is proposed in which a diffracting surface is provided in each of an imaging optical system and a synchronous detection optical system to reduce a shift of a printing position on a surface to be scanned due to a wavelength difference among a plurality of light sources and a shift of a condensed position on a light receiving surface of a synchronous detection unit due to an increase in temperature.

On the other hand, in the proposed light scanning apparatus, a shift of the condensed position on the light receiving surface of the synchronous detection unit in a direction parallel to an optical axis of the synchronous detection optical system due to the increase in temperature is also considered. However, since a total length of the synchronous detection optical system is large, a depth width is wide.

Accordingly, it is difficult to effectively apply the proposed structure to a compact synchronous detection optical system having a short total length in which the shift of the condensed position on the light receiving surface of the synchronous detection unit in the direction parallel to the optical axis due to the temperature increase is large.

As described above, in the light scanning apparatus proposed in the related art, a balance between a downsizing and a suppression of a change in an optical performance of the synchronous detection optical system due to a change in environmental temperature is not sufficiently considered.

Accordingly, an object of the present disclosure is to provide a light scanning apparatus capable of suppressing a decrease in synchronization detection accuracy due to a temperature change even in a synchronous detection optical system having a short total length.

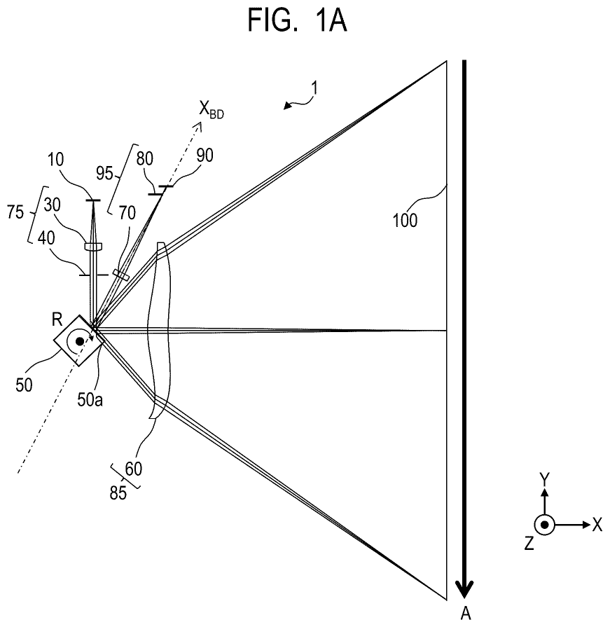

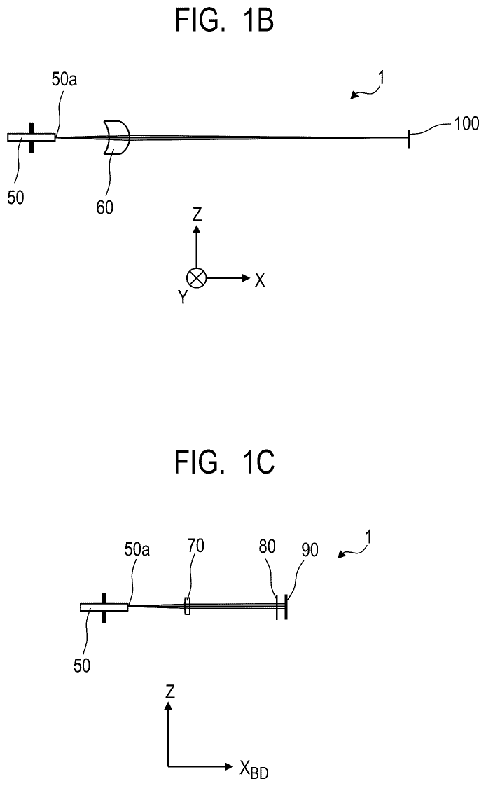

FIG. 1A shows a schematic main scanning cross sectional view of a light scanning apparatus 1 according to a first embodiment of the present invention.

FIG. 1B and FIG. 1C show schematic sub-scanning cross sectional views of an imaging optical system 85 and a synchronous detection optical system 95 provided in the light scanning apparatus 1 according to the first embodiment, respectively.

The light scanning apparatus 1 according to the present embodiment includes a light source 10, an incident optical element 30, a stop 40, a deflecting unit 50, a scanning optical element 60 (imaging optical element), a synchronous detection optical element 70 (first optical element), a synchronous detection edge unit 80, and a synchronous detection unit 90 (light receiving element).

As the light source 10, for example, a semiconductor laser can be used, and the number of light emitting points may be one or more.

The incident optical element 30 is an anamorphic lens having different positive powers in the main scanning cross section and the sub-scanning cross section.

The incident optical element 30 converts a light flux emitted from the light source 10 into a parallel light flux in the main scanning cross section, and condenses the light flux in the vicinity of a deflecting surface 50a of the deflecting unit 50 in the sub-scanning cross section.

The parallel light flux includes not only a strictly parallel light flux but also a substantially parallel light flux such as a weakly divergent light flux or a weakly convergent light flux.

The stop 40 has an elliptical opening, and limits a light flux diameter in each of the main scanning direction and the sub-scanning direction of the light flux that has passed through the incident optical element 30.

In the light scanning apparatus 1 according to the present embodiment, the stop 40 is formed integrally with a housing (not shown).

The deflecting unit 50 is a polygon mirror (rotary polygon mirror) formed by mirror-finishing an aluminum metal and having four reflecting surfaces each having a planar shape.

The deflecting unit 50 deflects the light flux that has passed through the stop 40 with rotating in a direction of arrow R in FIG. 1A by a driving unit such as a motor (not shown).

The scanning optical element 60 is formed by a so-called fe lens having a positive power in each of the main scanning cross section and the sub-scanning cross section.

The scanning optical element 60 condenses the light flux deflected by the deflecting unit 50 at a first timing in both of the main scanning cross section and the sub-scanning cross section.

The synchronous detection optical element 70 has a positive power in each of the main scanning cross section and the sub-scanning cross section.

The synchronous detection optical element 70 condenses the light flux deflected by the deflecting unit 50 at a second timing different from the first timing in the vicinity of the synchronous detection edge unit 80 in the main scanning cross section.

The synchronous detection edge unit 80 is configured to shield a part of the light flux that has passed through the synchronous detection optical element 70.

The synchronous detection unit 90 is configured to receive the light flux that has passed through the synchronous detection edge unit 80.

A controller (not shown) determines (controls) a writing start position (writing start timing) of the light flux for optically scanning a surface to be scanned 100 based on a signal obtained by the synchronous detection unit 90 receiving the light flux.

Each of the incident optical element 30, the scanning optical element 60, and the synchronous detection optical element 70 provided in the light scanning apparatus 1 according to the present embodiment is a plastic mold lens formed by injection-molding a plastic material.

Since a molded lens is easy to form an aspherical shape and is suitable for mass production, a productivity and an optical performance can be improved by using the plastic molded lens as the incident optical element 30, the scanning optical element 60, and the synchronous detection optical element 70.

The light flux emitted from the light source 10 passes through the incident optical element 30 and the stop 40, and is incident on (guided to) the deflecting unit 50 such that a line image elongated in the main scanning direction is formed on the deflecting surface 50a.

A light flux diameter of the light flux in the main scanning direction when the light flux is incident on the deflecting surface 50a of the deflecting unit 50 is smaller than a width of the deflecting surface 50a in the main scanning cross section.

Next, the light flux incident on the deflecting surface 50a of the deflecting unit 50 is deflected by the deflecting surface 50a.

Specifically, the light flux deflected by the deflecting surface 50a at the first timing is condensed in both of the main scanning cross section and the sub-scanning cross section such that a spot-like image is formed in the vicinity of the surface 100 by the scanning optical element 60.

The deflecting unit 50 rotates in the direction of the arrow R in FIG. 1A to optically scan the surface 100 at a constant speed in a direction of the arrow A in FIG. 1A, thereby an electrostatic latent image is formed on the surface 100.

Further, the light flux deflected by the deflecting surface 50a at the second timing different from the first timing passes through the synchronous detection optical element 70 to be condensed in the vicinity of the synchronous detection edge unit 80 in the main scanning cross section.

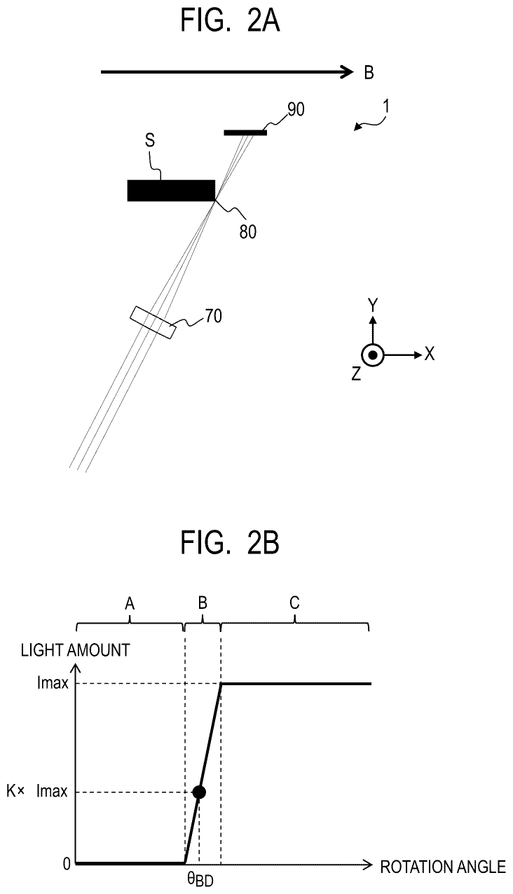

In the light scanning apparatus 1 according to the present embodiment, since the deflecting unit 50 rotates in the direction of the arrow R in FIG. 1A, the synchronous detection edge unit 80 is optically scanned in a direction of the arrow B as shown in FIG. 2A by the light flux that has passed through the synchronous detection optical element 70.

Accordingly, the light flux that has passed through the synchronous detection optical element 70 is shielded by the synchronous detection edge unit 80 until the deflecting unit 50 reaches a predetermined rotation angle.

When the deflecting unit 50 reaches the predetermined rotation angle, the light flux that has passed through the synchronous detection optical element 70 passes through the synchronous detection edge unit 80 to be guided to the synchronous detection unit 90.

In the light scanning apparatus 1 according to the present embodiment, an incident optical system 75 is formed by the incident optical element 30 and the stop 40.

Further, the imaging optical system 85 (first optical system) is formed by the scanning optical element 60, and the synchronous detection optical system 95 (second optical system) is formed by the synchronous detection optical element 70 and the synchronous detection edge unit 80.

Accordingly, in the light scanning apparatus 1 according to the present embodiment, an optical element having a refracting surface or a diffracting surface other than the synchronous detection optical element 70 is not provided in the synchronous detection optical system 95.

Further, in the light scanning apparatus 1 according to the present embodiment, the synchronous detection optical system 95 is arranged between the incident optical system 75 and the imaging optical system 85 in the main scanning cross section.

FIG. 2A shows a schematic main scanning cross sectional view in the vicinity of the synchronous detection unit 90 of the light scanning apparatus 1 according to the present embodiment.

As shown in FIG. 2A, the synchronous detection edge unit 80 provided in the light scanning apparatus 1 according to the present embodiment corresponds to the scanning direction of the synchronous detection unit 90, namely a downstream side end portion of a light shielding member S provided on an upstream side in the direction of the arrow B in FIG. 2A.

The synchronous detection edge unit 80 is arranged in the vicinity of an optical axis of the synchronous detection optical system 95.

That is, in the light scanning apparatus 1 according to the present embodiment, the light shielding member S for shielding a part of the light fluxes guided to respective positions in the main scanning direction on the light receiving surface of the synchronous detection unit 90 by the synchronous detection optical element 70 is provided.

The light shielding member S extends in a direction non-parallel to the optical axis of the synchronous detection optical system 95 such that a predetermined corner portion thereof is arranged at a predetermined position on the optical axis of the synchronous detection optical system 95, in the main scanning cross section.

As described above, the light flux deflected by the deflecting surface 50a at the second timing passes through the synchronous detection optical element 70, and then optically scans the light shielding member S including the synchronous detection edge unit 80 in the direction of the arrow B in FIG. 2A.

When the deflecting unit 50 reaches a predetermined rotation angle, the light flux passes through the synchronous detection edge unit 80 to be guided to the synchronous detection unit 90.

In the light scanning apparatus 1 according to the present embodiment, the light shielding member S is formed integrally with a housing (not shown).

FIG. 2B schematically shows a relationship between a rotation angle of the deflecting unit 50 and a light amount of the light flux received by the synchronous detection unit 90 in the light scanning apparatus 1 according to the present embodiment.

As shown in FIG. 2B, the rotation angle of the deflecting unit 50 is classified into one of regions A, B and C.

The rotation angle of the deflecting unit 50 is set so as to increase as the deflecting unit 50 rotates in the direction of the arrow R in FIG. 1A.

When the deflecting unit 50 deflects the incident light flux at the rotation angle included in the region A, the light amount of the light flux received by the synchronous detection unit 90 becomes 0 since the deflected light flux is shielded by the light shielding member S.

Next, when the deflecting unit 50 deflects the incident light flux at the rotation angle included in the region B, only a part of the deflected light flux is shielded by the light shielding member S.

Therefore, the light amount of the light flux received by the synchronous detection unit 90 becomes a value between 0 and the maximum value Iₘₐₓ since the rest of the light flux is received by the synchronous detection unit 90.

When the deflecting unit 50 deflects the incident light flux at the rotation angle included in the region C, the light amount of the light flux received by the synchronous detection unit 90 becomes the maximum value Iₘₐₓ since all of the deflected light flux is received by the synchronous detection unit 90.

Here, in the light scanning apparatus 1 according to the present embodiment, a value K×Iₘₐₓ obtained by multiplying the maximum value Iₘₐₓ by a predetermined value K between 0 and 1 is set as a threshold value (slice level). The predetermined value K is 0.4, for example.

Then, the rotation angle of the deflecting unit 50 when the light amount of the light flux received by the synchronous detection unit 90 reaches the threshold value K×Iₘₐₓ is set as a synchronization detection angle θ_{BD}.

That is, in the light scanning apparatus 1 according to the present embodiment, the controller (not shown) determines the writing start position of the light flux for optically scanning the surface 100 based on the synchronization detection angle θ_{BD}.

In FIG. 2B, the light amount linearly changes between 0 and the maximum value Iₘₐₓ in the region B, but the change in the light amount in the region B is not limited thereto.

Further, the light amount is maintained at the maximum value Iₘₐₓ and does not change in the region C, but the change in the light amount in the region C is not limited thereto.

As described above, in the light scanning apparatus 1 according to the present embodiment, the light flux deflected by the deflecting unit 50 at the second timing passes through the synchronous detection optical element 70 to be condensed in the vicinity of the synchronous detection edge unit 80 in the main scanning cross section.

In other words, when temperature of the light scanning apparatus 1, namely environmental temperature is a predetermined temperature, the light flux deflected by the deflecting unit 50 at the second timing is condensed at a predetermined position in the vicinity of the synchronous detection edge unit 80 by the synchronous detection optical element 70 in the main scanning cross section.

Therefore, it becomes possible to shorten time required for the light amount of the light flux received by the synchronous detection unit 90 to reach the maximum value Iₘₐₓ from 0, namely to narrow the region B.

This makes it possible to reduce a variation in the synchronization detection angle θ_{BD} determined from the threshold value K×Iₘₐₓ due to the steep inclination of the change in the light amount in the region B, thereby improving the synchronization detection accuracy.

Next, specification values, a refractive index and coordinates of each optical surface, and a shape of each optical surface in the light scanning apparatus 1 according to the present embodiment are shown in the following Table 1, Table 2 and Table 3.

TABLE 1

| | Parameter | |
|---|---|---|
| Item | [Unit] | Value |
| Wavelength of light source 10 | λ[nm] | 793 |
| Width of surface to be scanned 100 | h[mm] | 214 |
| Number of deflecting surfaces 50a in deflecting unit 50 | [Surfaces] | 4 |
| Circumscribed diameter of deflecting unit 50 | Pd[mm] | 20 |
| Coordinates of rotation center of deflecting unit 50 | (X, Y)[mm] | (−5.69, 4.31) |
| Width in main scanning direction of opening formed in stop 40 | Am[mm] | 2.52 |
| Width in sub-scanning direction of opening formed in stop 40 | As[mm] | 1.32 |
| Total length of imaging optical system 85 | Tc[mm] | 141.50 |
| Focal length of imaging optical system 85 in main scanning | fθ[mm] | 126.61 |
| cross section | | |
| Total length of synchronous detection optical system 95 | D_BD[mm] | 63.54 |
| Focal length of synchronous detection optical element 70 in | fm[mm] | 38.26 |
| main scanning cross section | | |
| Focal length of synchronous detection optical element 70 in | fs[mm] | 28.91 |
| sub-scanning cross section | | |
| Focal length in main scanning cross section of diffractive | fdm[mm] | 49.81 |
| component of synchronous detection optical element 70 | | |
| Focal length in main scanning cross section of refractive | frm[mm] | 160.70 |
| component of synchronous detection optical element 70 | | |

TABLE 2

| | | Coordinates of | | | | | |
|---|---|---|---|---|---|---|---|
| | Refractive | surface vertex | | | Direction cosine of | | |
| | index | (center) | | | optical axis | | |
| Optical surface | (λ = 793 nm) | tc(x) | tc(y) | tc(z) | gx(x) | gx(y) | gx(z) |
| Light emission point of light source 10 | — | 0.00 | 51.80 | 0.00 | 0.00 | 1.00 | 0.00 |
| Incident surface of incident optical element 30 | 1.53 | 0.00 | 34.67 | 0.00 | 0.00 | 1.00 | 0.00 |
| Exit surface of incident optical element 30 | — | 0.00 | 31.67 | 0.00 | 0.00 | 1.00 | 0.00 |
| Stop 40 | — | 0.00 | 22.00 | 0.00 | 0.00 | 0.00 | 0.00 |
| Deflecting surface 50a of deflecting unit 50 | — | 0.00 | −0.69 | 0.69 | 0.71 | 0.71 | 0.00 |
| (when on-axis image height is scanned) | | | | | | | |
| Incident surface of scanning optical element 60 | 1.53 | 21.73 | 0.02 | 0.00 | 1.00 | 0.00 | 0.00 |
| Exit surface of scanning optical element 60 | — | 29.93 | 0.02 | 0.00 | 1.00 | 0.00 | 0.00 |
| Incident surface of synchronous detection optical | 1.53 | 10.58 | 22.01 | 0.00 | 0.46 | 0.89 | 0.00 |
| element 70 | | | | | | | |
| Exit surface of synchronous detection optical | — | 11.49 | 23.79 | 0.00 | 0.46 | 0.89 | 0.00 |
| element 70 | | | | | | | |
| Synchronous detection edge unit 80 | — | 27.84 | 55.35 | 0.00 | 0.00 | 1.00 | 0.00 |
| Synchronous detection unit 90 | — | 29.22 | 58.01 | 0.00 | 0.00 | 1.00 | 0.00 |
| Surface to be scanned 100 | — | 141.50 | 0.02 | 0.00 | 1.00 | 0.00 | 0.00 |

TABLE 3

| | Aspherical surface coefficient | | | | | | |
|---|---|---|---|---|---|---|---|
| | | Incident optical | | Scanning optical | | Synchronous detection | |
| | | element 30 | | element 60 | | optical element 70 | |
| | | Incident | Exit | Incident | Exit | Incident | Exit |
| | Coefficient | surface | surface | surface | surface | surface | surface |
| Meridional | R | — | −9.78E+00 | 4.19E+01 | 7.93E+01 | 8.49E+01 | — |
| line | K | — | — | 1.07E−02 | 1.75E−01 | — | — |
| | B1 | — | — | — | — | — | — |
| | B2u | — | — | — | — | — | — |
| | B2l | — | — | — | — | — | — |
| | B3 | — | — | — | — | — | — |
| | B4u | — | — | −2.27E−05 | −1.36E−05 | — | — |
| | B4l | — | — | −2.49E−05 | −1.52E−05 | — | — |
| | B5 | — | — | — | — | — | — |
| | B6u | — | — | 2.53E−08 | 8.15E−09 | — | — |
| | B6l | — | — | 3.22E−08 | 1.21E−08 | — | — |
| | B7 | — | — | — | — | — | — |
| | B8u | — | — | −1.79E−11 | 1.05E−12 | — | — |
| | B8l | — | — | −2.83E−11 | −3.36E−12 | — | — |
| | B9 | — | — | — | — | — | — |
| | B10u | — | — | 1.57E−15 | −4.96E−15 | — | — |
| | B10l | — | — | 4.00E−15 | −4.21E−15 | — | — |
| | B11 | — | — | — | — | — | — |
| | B12u | — | — | 6.45E−18 | 9.81E−19 | — | — |
| | B12l | — | — | 1.21E−17 | 5.22E−19 | — | — |
| | B13 | — | — | — | — | — | — |
| | B14u | — | — | −3.82E−21 | 2.10E−21 | — | — |
| | B14l | — | — | −8.90E−21 | 3.40E−21 | — | — |
| | B15 | — | — | — | — | — | — |
| | B16u | — | — | 4.87E−25 | −1.03E−24 | — | — |
| | B16l | — | — | 1.67E−24 | −1.85E−24 | — | — |
| Sagittal | r | — | −6.26E+00 | −1.14E+01 | −7.53E+00 | 3.54E+01 | — |
| line | E1 | — | — | −6.41E−04 | −2.88E−04 | — | — |
| | E2u | — | — | 3.32E−04 | 1.97E−04 | — | — |
| | E2l | — | — | 2.73E−04 | 1.81E−04 | — | — |
| | E3 | — | — | — | — | — | — |
| | E4u | — | — | −7.57E−07 | −4.15E−07 | — | — |
| | E4l | — | — | −5.99E−07 | −3.72E−07 | — | — |
| | E5 | — | — | — | — | — | — |
| | E6u | — | — | 1.91E−09 | 7.92E−10 | — | — |
| | E6l | — | — | 1.05E−09 | 6.07E−10 | — | — |
| | E7 | — | — | — | — | — | — |
| | E8u | — | — | −3.64E−12 | −7.60E−13 | — | — |
| | E8l | — | — | −2.31E−12 | −3.46E−13 | — | — |
| | E9 | — | — | — | — | — | — |
| | E10u | — | — | 4.10E−15 | −2.97E−17 | — | — |
| | E10l | — | — | 4.29E−15 | −1.44E−15 | — | — |
| | E11 | — | — | — | — | — | — |
| | E12u | — | — | −2.25E−18 | 7.90E−19 | — | — |
| | E12l | — | — | −3.20E−18 | 3.78E−18 | — | — |
| | E13 | — | — | — | — | — | — |
| | E14u | — | — | 2.47E−22 | −7.06E−22 | — | — |
| | E14l | — | — | −5.13E−22 | −3.42E−21 | — | — |
| | E15 | — | — | — | — | — | — |
| | E16u | — | — | 1.79E−25 | 2.14E−25 | — | — |
| | E16l | — | — | 1.09E−24 | 1.05E−24 | — | — |
| Phase | C2 | — | — | — | — | — | −1.00E−02 |
| coefficient | | | | | | | |

A shape (meridional line shape) in the main scanning cross section of each of an incident surface and an exit surface of the scanning optical element 60 provided in the light scanning apparatus 1 according to the present embodiment has an aspherical shape represented by a polynomial function up to 16th order.

Specifically, in each of the incident surface and the exit surface of the scanning optical element 60, an intersection point (surface vertex) with the optical axis is set as an origin, an axis parallel to the optical axis is set as an X axis, an axis orthogonal to the optical axis in the main scanning cross section is set as a Y axis, and an axis orthogonal to the optical axis in the sub-scanning cross section is set as a Z axis.

At this time, shapes of the incident surface and the exit surface of the scanning optical element 60 in the main scanning cross section are expressed by the following Expression (1):

$$X = \frac{\frac{{Y}^{2}}{R}}{1 + \sqrt{1 - ( 1 + K ) {( \frac{Y}{R} )}^{2}}} + {\sum }_{i = 1}^{16} {B}_{i} {Y}^{i} . \qquad ( 1 )$$

In Expression (1), R represents a curvature radius (curvature radius of meridional line) in the main scanning cross section, K represents an eccentricity, and Bᵢ (i=1, 2, 3, . . . , 16) represent aspherical coefficients.

Further, shapes (sagittal line shapes) in the sub-scanning cross section of the incident surface and the exit surface of the scanning optical element 60 provided in the light scanning apparatus 1 according to the present embodiment are expressed by the following Expression (2):

$$S = \frac{\frac{{Z}^{2}}{{r}^{′}}}{1 + \sqrt{1 - {( \frac{Z}{{r}^{′}} )}^{2}}} . \qquad ( 2 )$$

In Expression (2), S represents a sagittal line shape defined in a cross section which includes a normal of a meridional line at each position in the main scanning direction and is perpendicular to the main scanning cross section.

Furthermore, a curvature radius (curvature radius of sagittal line) r′ in the sub-scanning cross section at a position away from the optical axis by Y in the main scanning direction is expressed by the following Expression (3):

$$\frac{1}{{r}^{′}} = \frac{1}{r} + {\sum }_{i = 1}^{16} {E}_{i} {Y}^{i} . \qquad ( 3 )$$

In Expression (3), r represents a curvature radius (curvature radius of sagittal line) in the sub-scanning cross section on the optical axis, and Eᵢ (i=1, 2, 3, . . . , 16) represent variation coefficients of sagittal line.

Note that the aspherical coefficients B₂, B₄, B₆, B₈, B₁₀, B₁₂, B₁₄ and B₁₆ of the even-order terms of Y in Expression (1) are set to values different from each other between a region of Y≥0 and a region of Y<0.

That is, for each of the aspherical coefficients B₂, B₄, B₆, B₈, B₁₀, B₁₂, B₁₄ and B₁₆, a coefficient with a subscript u corresponding to the upper region of Y≥0 and a coefficient with a subscript 1 corresponding to the lower region of Y<0 are set.

Similarly, the aspherical coefficients E₂, E₄, E₆, E₈, E₁₀, E₁₂, E₁₄ and E₁₆ of the even-order terms of Y in Expression (3) are set to values different from each other between the region of Y≥0 and the region of Y<0.

That is, for each of the aspherical coefficients E₂, E₄, E₆, E₈, E₁₀, E₁₂, E₁₄ and E₁₆, a coefficient with a subscript u corresponding to the upper region of Y≥0 and a coefficient with a subscript 1 corresponding to the lower region of Y<0 are set.

Further, an exit surface of the synchronous detection optical element 70 provided in the light scanning apparatus 1 according to the present embodiment is formed as a diffracting surface on which a diffraction grating is formed.

Specifically, the exit surface of the synchronous detection optical element 70 is formed as the diffracting surface defined by a phase function q expressed by the following Expression (4):

$$ϕ = \frac{2 π}{λ} ( {C}_{2} \sqrt{{Y}^{2} + {Z}^{2}} ) . \qquad ( 4 )$$

In Expression (4), λ represents a wavelength (design wavelength) of the light flux emitted from the light source 10, specifically, is 793 nm.

In the light scanning apparatus 1 according to the present embodiment, first order diffracted light is used.

In the light scanning apparatus 1 according to the present embodiment, all of the values of the aspherical coefficients Bᵢ and the sagittal line variation coefficients Eᵢ for the incident surface of the synchronous detection optical element 70 are set to 0. However, the present invention is not limited thereto, and at least one of these values may be set to a value other than 0.

In addition, in the light scanning apparatus 1 according to the present embodiment, the shape of each optical surface is defined by the functions expressed by Expressions (1) to (4), but the definition of the shape of each optical surface is not limited thereto.

Next, influence of temperature increase on optical performance in the light scanning apparatus 1 according to the present embodiment is described.

When the semiconductor laser used in the light source 10 is turned on, self-heating occurs and the temperature of the semiconductor laser increases, thereby increasing environmental temperature.

Further, a driving unit such as a motor for rotating the deflecting unit 50 generates heat to increase the environmental temperature.

Such change in the environmental temperature mainly causes the following three influences on the optical performance of the light scanning apparatus 1 according to the present embodiment.

As a first influence, a wavelength of the semiconductor laser forming the light source 10 changes, which is so-called mode hopping.

In general, an oscillation wavelength of a semiconductor laser increases as the temperature increases. A variation amount in the oscillation wavelength per unit temperature varies depending on a type and individual difference of the laser element used.

For example, the semiconductor laser can be used as the light source 10, which has a general characteristic value that the wavelength λ changes by 0.26 nm when the temperature T changes by 1° C., namely dA/dT=0.26 (nm/° C.).

As a second influence, refractive index of an optical element arranged in the vicinity of the semiconductor laser or the motor changes due to an increase in the environmental temperature caused by an increase in the temperature of the semiconductor laser or the motor.

Specifically, in the light scanning apparatus 1 according to the present embodiment, the refractive index of each of the incident optical element 30 and the synchronous detection optical element 70, which are arranged in the vicinity of the light source 10 and the deflecting unit 50 and are formed by plastic mold lenses, changes.

In general, the refractive index of a resin material decreases when the temperature increases, whereas a variation amount in the refractive index per unit temperature varies depending on a type and individual difference of the resin material used.

For example, each of the incident optical element 30 and the synchronous detection optical element 70 can be formed by the resin material having a general characteristic value that the refraction index n changes by −9.9×10⁻⁵ when the temperature T changes by 1° C., namely dn/dT=−9.9×10⁻⁵ (/° C.).

As a third influence, when the temperature of the semiconductor laser or the motor increases and the environmental temperature increases, the shapes of the incident optical element 30 and the synchronous detection optical element 70 arranged in the vicinity of the light source 10 or the deflecting unit 50 change.

In general, since an optical element formed by a resin material expands when the temperature increases, power of an optical surface of the optical element decreases, whereas thermal expansion rate of the optical element per unit temperature varies depending on a type and individual difference of the resin material used.

Specifically, each of the incident optical element 30 and the synchronous detection optical element 70 can be formed by a resin material with the thermal expansion rate which isotropically expands by 0.008% when the temperature increases by 1° C. as a general characteristic value.

The above-described three influences on the optical performance of the light scanning apparatus 1 according to the present embodiment are not limited to the above-described characteristic values of the semiconductor laser forming the light source 10, the incident optical element 30, the synchronous detection optical element 70 or the like.

Due to the above-described three influences, synchronization detection performance in the light scanning apparatus 1 according to the present embodiment changes as described below.

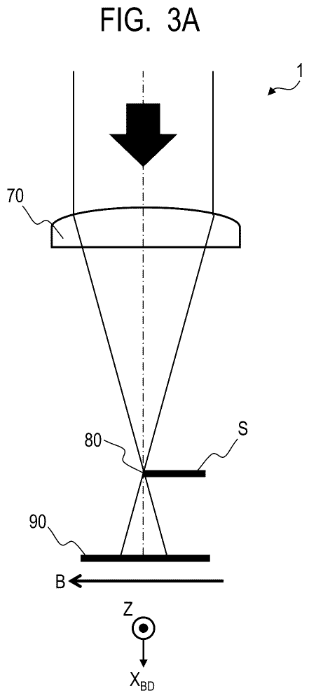

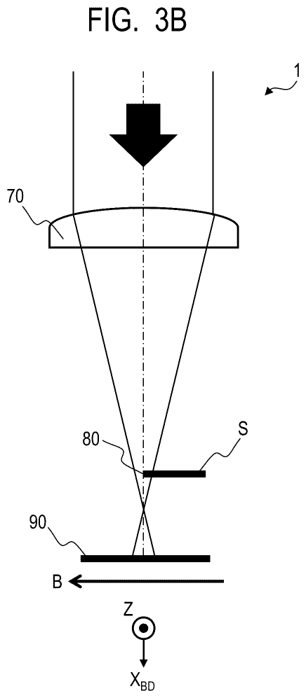

FIG. 3A and FIG. 3B show schematic main scanning cross sectional views in the vicinity of the synchronous detection unit 90 of the light scanning apparatus 1 according to the present embodiment.

Note that FIG. 3A shows a state in which the light flux is received by the synchronous detection unit 90 when the environmental temperature does not increase, whereas FIG. 3B shows a state in which the light flux is received by the synchronous detection unit 90 when the environmental temperature increases.

As shown in FIG. 3A, when the environmental temperature does not increase, the light flux that has passed through the synchronous detection optical element 70 is condensed in the vicinity of the synchronous detection edge unit 80 in the main scanning cross section.

On the other hand, as shown in FIG. 3B, when the environmental temperature increases, the light flux that has passed through the synchronous detection optical element 70 is condensed on a downstream side of the synchronous detection edge unit 80 in the main scanning cross section.

That is, in this case, defocus occurs on a rear side, and a spot formed by the light flux at the position of the synchronous detection edge unit 80 is enlarged, so that a variation in the synchronization detection angle θ_{BD} increases, thereby the synchronization detection accuracy deteriorates.

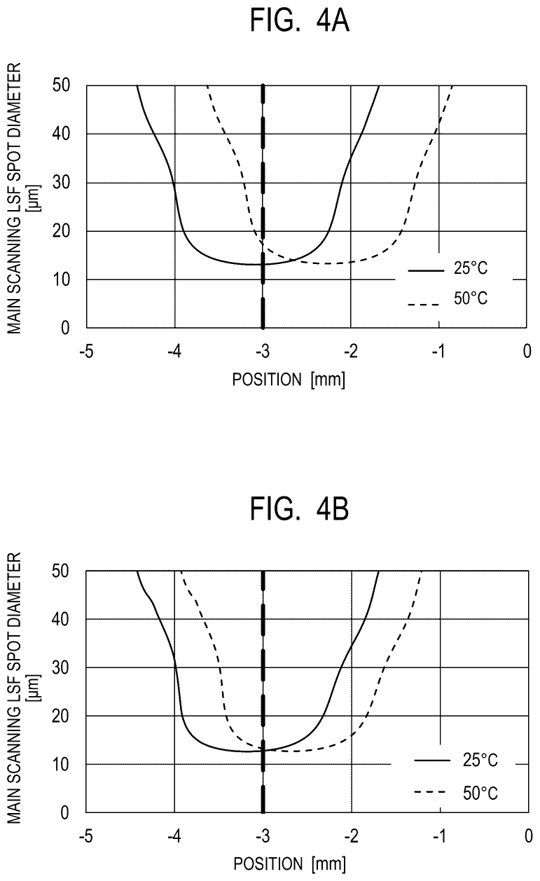

FIG. 4A shows a change in a main scanning line spread function (LSF) spot diameter with respect to a change in a position in a direction parallel to an optical axis of a synchronous detection optical system 95 in a light scanning apparatus according to a comparative example, namely a defocus characteristic of the main scanning LSF spot diameter.

The light scanning apparatus according to the comparative example shown here has the same structure as the light scanning apparatus 1 according to the present embodiment except that a predetermined synchronous detection optical element is provided instead of the synchronous detection optical element 70, so that the same members are denoted by the same reference numerals, and the description thereof is omitted.

Specifically, in the predetermined synchronous detection optical element, a diffracting surface is not formed on the exit surface, namely each of the incident surface and the exit surface is formed by only a refracting surface, whereas the predetermined synchronous detection optical element has the same shape as that of the synchronous detection optical element 70, thereby the power is maintained.

Further, the main scanning LSF spot diameter shown in FIG. 4A is the main scanning LSF spot diameter of the light flux deflected toward the synchronous detection unit 90 by the deflecting unit 50 at the second timing as described above.

The main scanning LSF spot diameter means a width when a light amount profile obtained by integrating a spot profile in the sub-scanning direction at each position in the main scanning direction is sliced at a position of 50% with respect to the maximum value.

Further, in FIG. 4A, a change in the main scanning LSF spot diameter at 25° C. at which the environmental temperature does not increase is indicated by a solid line, whereas a change in the main scanning LSF spot diameter at 50° C. at which the environmental temperature increases is indicated by a broken line.

As for the position in the direction parallel to the optical axis of the synchronous detection optical system 95 on the horizontal axis of FIG. 4A, 0 mm corresponds to the position of the synchronous detection unit 90, and −3.00 mm corresponds to the position of the synchronous detection edge unit 80.

As shown in FIG. 4A, in the light scanning apparatus according to the comparative example, when the environmental temperature increases from 25° C. to 50° C., a focus position at which the main scanning LSF spot diameter takes a minimum value shifts to the downstream side.

Accordingly, the main scanning LSF spot diameter at the position of the synchronous detection edge unit 80 increases by about 1.3 times.

Further, when the environmental temperature increases to a temperature higher than 50° C., the defocus further increases, so that the main scanning LSF spot diameter at the position of the synchronous detection edge unit 80 further increases.

The synchronization detection performance also changes due to a manufacturing error or the like of a housing or each optical element provided in the light scanning apparatus according to the comparative example.

Further, as in the light scanning apparatus according to the comparative example, in a structure in which an edge unit or an equivalent slit unit is provided on the synchronous detection optical system and the light flux is condensed in the vicinity of it in the main scanning cross section to improve the synchronization detection accuracy, the influence of the defocus described above also changes depending on a depth width.

That is, in a structure in which a total length of the synchronous detection optical system is short or a focal length of the synchronous detection optical system in the main scanning cross section is short and thus the depth width is narrow, the variation of the spot diameter due to the defocus caused by the temperature increase is likely to appear remarkably.

Accordingly, in the light scanning apparatus 1 according to the present embodiment, the synchronous detection optical element 70 has diffractive power (power due to diffraction) in the synchronous detection optical system 95 having a short total length, thereby suppressing a decrease in synchronization detection accuracy due to an increase in temperature.

Specifically, when the environmental temperature increases, the refractive indices of the incident optical element 30 and the synchronous detection optical element 70 decrease and they expand.

At this time, the focus by the incident optical element 30 and the synchronous detection optical element 70 is shifted so as to be further away from the light source 10.

On the other hand, in the light scanning apparatus 1 according to the present embodiment, the oscillation wavelength becomes longer as the temperature of the light source 10 increases.

At this time, in accordance with the diffractive power of the synchronous detection optical element 70, the focus by the incident optical element 30 and the synchronous detection optical element 70 shifts so as to be closer to the light source 10.

That is, in the light scanning apparatus 1 according to the present embodiment, the above-described two shifts can be canceled out each other by appropriately setting the diffractive power in the synchronous detection optical element 70.

Thereby, enlargement of the spot at the position of the synchronous detection edge unit 80 can be suppressed.

Specifically, in the light scanning apparatus 1 according to the present embodiment, when f_{dm} and fᵣₘ represent focal lengths in the main scanning cross section due to only the diffractive power and only the refractive power (power due to refraction) of the synchronous detection optical element 70, respectively, the following Inequality (5) is satisfied:

$$0 < \frac{{f}_{d m}}{{f}_{rm}} \leq 1 \text{.00} . \qquad ( 5 )$$

In other words, in the light scanning apparatus 1 according to the present embodiment, a value of the diffractive power of the synchronous detection optical element 70 is equal to or larger than a value of the refractive power of the synchronous detection optical element 70 in the main scanning cross section.

In the light scanning apparatus 1 according to the present embodiment, it is possible to suppress a decrease in synchronization detection accuracy due to a temperature change even in the synchronous detection optical system 95 which is small and has a short total length by increasing the value of the diffractive power of the synchronous detection optical element 70 so as to satisfy Inequality (5).

In the light scanning apparatus 1 according to the present embodiment, it is preferred that the following Inequality (5a) be satisfied instead of Inequality (5):

$$0.1 \leq \frac{{f}_{dm}}{{f}_{rm}} \leq 0.9 . \qquad ( 5 a )$$

In the light scanning apparatus 1 according to the present embodiment, it is more preferred that the following Inequality (5b) be satisfied instead of Inequality (5a):

$$0.2 \leq \frac{{f}_{dm}}{{f}_{rm}} \leq 0.8 . \qquad ( 5 b )$$

Since f_{dm}/fᵣₘ=49.81/160.70=0.31 in the light scanning apparatus 1 according to the present embodiment, Inequalities (5), (5a) and (5b) are satisfied.

FIG. 4B shows a change in the main scanning LSF spot diameter with respect to a change in the position in the direction parallel to the optical axis of the synchronous detection optical system 95 in the light scanning apparatus 1 according to the present embodiment, namely a defocus characteristic of the main scanning LSF spot diameter.

The main scanning LSF spot diameter shown in FIG. 4B is the main scanning LSF spot diameter of the light flux deflected toward the synchronous detection unit 90 by the deflecting unit 50 at the second timing as described above.

Further, in FIG. 4B, a change in the main scanning LSF spot diameter at 25° C. at which the environmental temperature does not increase is indicated by a solid line, whereas a change in the main scanning LSF spot diameter at 50° C. at which the environmental temperature increases is indicated by a broken line.

As for the position in the direction parallel to the optical axis of the synchronous detection optical system 95 on the horizontal axis of FIG. 4B, 0 mm corresponds to the position of the synchronous detection unit 90, and −3.00 mm corresponds to the position of the synchronous detection edge unit 80.

As shown in FIG. 4B, in the light scanning apparatus 1 according to the present embodiment, when the environmental temperature increases from 25° C. to 50° C., the focus position at which the main scanning LSF spot diameter takes a minimum value shifts to a downstream side.

On the other hand, a magnitude of the shift is relatively smaller than that of the light scanning apparatus according to the comparative example.

Therefore, even when the environmental temperature increases from 25° C. to 50° C., the main scanning LSF spot diameter at the position of the synchronous detection edge unit 80 hardly changes, namely an increase in the main scanning LSF spot diameter can be suppressed.

That is, in the light scanning apparatus 1 according to the present embodiment, since the synchronous detection optical element 70 has a diffractive power, it is possible to suppress a decrease in synchronization detection accuracy due to a temperature increase.

Further, in the light scanning apparatus 1 according to the present embodiment, the light flux deflected toward the synchronous detection unit 90 by the deflecting unit 50 at the second timing as described above may be reflected by the incident surface of the synchronous detection optical element 70.

Then, ghost light (return light) that returns to the light source 10 again due to the surface reflection of the light flux is generated, which may degrade the optical performance of the light scanning apparatus 1 including a light emission accuracy of the light source 10.

On the other hand, the incident surface of the synchronous detection optical element 70 provided in the light scanning apparatus 1 according to the present embodiment has a curved shape in which a diffraction grating is not formed, namely is formed as a refracting surface, and the exit surface thereof is formed as a diffracting surface in which the diffraction grating is formed on a flat surface.

Thereby, light generated by the surface reflection of the light flux on the incident surface of the synchronous detection optical element 70 can be set as divergent light.

Accordingly, it is possible to suppress a decrease in the optical performance of the light scanning apparatus 1 by reducing a light amount of the ghost light that returns to the light source 10 again.

The incident surface of the synchronous detection optical element 70 may be tilted to reflect the light flux on the incident surface such that the light flux does not return to the light source 10, or an antireflection film may be provided on the incident surface of the synchronous detection optical element 70 to reduce a light amount of light generated by the surface reflection of the light flux.

As described above, in the light scanning apparatus 1 according to the present embodiment, of the incident surface and the exit surface of the synchronous detection optical element 70, the exit surface is formed as a diffracting surface.

In the light scanning apparatus 1 according to the present embodiment, the synchronous detection optical element 70 is a plastic mold lens formed by injection molding as described above.

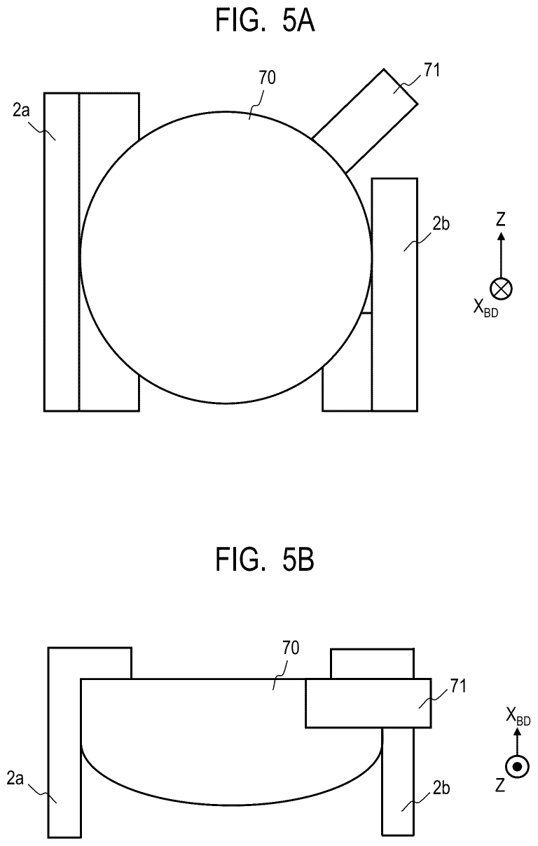

When a diffracting surface is formed in a plastic molded lens having two optical surfaces, the optical surface on a side fixed to a mold is generally formed as the diffracting surface, and a gate portion 71 (FIGS. 5A and 5B) is arranged due to a structure of the mold.

Therefore, in the light scanning apparatus 1 according to the present embodiment, of the incident surface and the exit surface of the synchronous detection optical element 70, only the exit surface is formed as the diffracting surface, and the gate portion 71 is formed on the exit surface.

When the synchronous detection optical element 70 is formed by a method other than injection molding, such as cutting, the formation of the diffracting surface and the arrangement of the gate portion 71 are not limited to those described above.

That is, both of the incident surface and the exit surface of the synchronous detection optical element 70 may be the diffracting surfaces, in other words, at least one of the incident surface and the exit surface of the synchronous detection optical element 70 may be the diffracting surface.

Further, in the light scanning apparatus 1 according to the present embodiment, it is preferred that a gate portion (not shown) provided in the incident optical element 30 and the gate portion 71 provided in the synchronous detection optical element 70 are arranged such that their relative positions with respect to the optical axis do not coincide with each other.

Thereby, it is possible to suppress a significant deterioration in optical performance due to a superimposition of birefringence which is likely to occur in the vicinity of each of the gate portion provided in the incident optical element 30 and the gate portion 71 provided in the synchronous detection optical element 70.

FIG. 5A and FIG. 5B show a schematic front view and a schematic top view of the synchronous detection optical element 70 provided in the light scanning apparatus 1 according to the present embodiment, respectively.

The synchronous detection optical element 70 provided in the light scanning apparatus 1 according to the present embodiment is a plastic molded lens with an incident surface and an exit surface each having a rotationally symmetrical shape.

Specifically, the synchronous detection optical element 70 is a so-called round lens having a circular shape in a cross section perpendicular to the optical axis, except for the gate portion 71.

As shown in FIG. 5A and FIG. 5B, in the light scanning apparatus 1 according to the present embodiment, the synchronous detection optical element 70 is supported by supporting units 2a and 2b integrally formed with a housing (not shown).

Specifically, the synchronous detection optical element 70 abuts against the supporting units 2a and 2b in the X_{BD} direction, and is supported by being lightly press-fitted into a space between the supporting units 2a and 2b in a direction perpendicular to the X_{BD} direction and the Z direction.

The synchronous detection optical element 70 is supported by a bottom surface portion (not shown) formed integrally with the housing in the Z direction.

When the synchronous detection optical element 70 is assembled in the housing in the light scanning apparatus 1 according to the present embodiment, the synchronous detection optical element 70 is inserted into the space between the supporting units 2a and 2b from a positive side in the Z direction.

Therefore, at the time of the insertion, the synchronous detection optical element 70 is positioned such that the gate portion 71 is arranged on a positive side in the Z direction with respect to a cross section including a center of the synchronous detection optical element 70 and perpendicular to the Z direction.

In FIG. 5A, the synchronous detection optical element 70 is supported such that the gate portion 71 and the supporting unit 2b do not abut on each other, but the present invention is not limited thereto, and the synchronous detection optical element 70 may be supported such that they abut on each other.

In addition, the synchronous detection optical element 70 can be more firmly supported by being bonded to the supporting units 2a and 2b with an ultraviolet curable adhesive.

Further, in the light scanning apparatus 1 according to the present embodiment, a height in the Z direction of the supporting unit 2b provided on a downstream side of the supporting unit 2a in the rotation direction of the deflecting unit 50 is smaller than that of the supporting unit 2a.

As shown in FIG. 2A, the light flux that has passed through an upstream side of the synchronous detection unit 90 in the scanning direction with respect to the center of the synchronous detection optical element 70 is shielded by the light shielding member S.

On the other hand, the light flux that has passed through a downstream side of the synchronous detection unit 90 in the scanning direction with respect to the center of the synchronous detection optical element 70 is guided to the synchronous detection unit 90 without being shielded by the light shielding member S.

Accordingly, in the light scanning apparatus 1 according to the present embodiment, a scanned width of the synchronous detection unit 90 on the downstream side in the scanning direction is increased by reducing the height of the supporting unit 2b in the Z direction.

Further, in the light scanning apparatus 1 according to the present embodiment, a value of a combined power of the refractive power and the diffractive power in the sub-scanning cross section of the synchronous detection optical element 70 is set to be positive.

On the other hand, in the structure in which the light flux is condensed at a position in the vicinity of the synchronous detection edge unit 80 in the main scanning cross section as in the light scanning apparatus 1 according to the present embodiment, it is not preferred to condense the light flux at the position in the sub-scanning cross section.

As described above, the synchronous detection edge unit 80 is formed integrally with the housing of the light scanning apparatus 1, and there is a possibility that a manufacturing error is included in a surface or a ridge line portion of the synchronous detection edge unit 80 or a foreign substance such as dust or fluff is attached thereto.

If the light flux is condensed in the vicinity of such synchronous detection edge unit 80 in both of the main scanning cross section and the sub-scanning cross section, a light amount of the light flux when reaching the synchronous detection unit 90 may greatly change in accordance with the error of the synchronous detection edge unit 80.

Therefore, in the light scanning apparatus 1 according to the present embodiment, the light flux deflected toward the synchronous detection unit 90 by the deflecting unit 50 at the second timing is not condensed at a position in the vicinity of the synchronous detection edge unit 80 in the sub-scanning cross section, but is condensed at a position different from the above-described position.

Thereby, it is possible to reduce a sensitivity of the light amount of the light flux when reaching the synchronous detection unit 90 with respect to the error of the synchronous detection edge unit 80.

On the other hand, the combined power in the sub-scanning cross section of the synchronous detection optical element 70 provided in the light scanning apparatus 1 according to the present embodiment is set such that the light flux having a light flux diameter satisfying a signal intensity (namely, a synchronization detection light amount) necessary for an operation in the synchronous detection unit 90 is received.

Further, in the light scanning apparatus 1 according to the present embodiment, the synchronous detection optical element 70 has a positive diffractive power in the sub-scanning cross section.

Thereby, similarly to the main scanning LSF spot diameter, it is possible to suppress an increase in a sub-scanning LSF spot diameter at the position of the synchronous detection edge unit 80 due to an increase in the environmental temperature.

The sub-scanning LSF spot diameter refers to a width when a light amount profile obtained by integrating a spot profile in the main scanning direction at each position in the sub-scanning direction is sliced at a position of 50% with respect to the maximum value thereof.

The positive diffractive power of the synchronous detection optical element 70 in the sub-scanning cross section is set to prevent the light flux from being condensed at a position in the vicinity of the synchronous detection edge unit 80 in the sub-scanning cross section due to defocus caused by a change in environmental temperature.

In addition, the positive diffractive power of the synchronous detection optical element 70 in the sub-scanning cross section is set to maintain a signal intensity necessary for the operation by suppressing a variation in light flux diameter of the light flux when the light flux is received by the synchronous detection unit 90.

This makes it possible to suppress variations not only in the synchronization detection angle θ_{BD} but also in the synchronization detection light amount acquired by the synchronous detection unit 90.

Further, in the light scanning apparatus 1 according to the present embodiment, the synchronous detection optical element 70 is arranged so as to face the optical axis of the synchronous detection optical system 95.

In other words, in the light scanning apparatus 1 according to the present embodiment, the optical axis of the synchronous detection optical system 95 passes through the surface vertex of each of the incident surface and the exit surface of the synchronous detection optical element 70.

If the synchronous detection optical element 70 does not face the optical axis, diffracted light of the second or higher order spreads in a cross section perpendicular to the optical axis.

In this case, when the deflecting unit 50 rotates at a rotation angle different from the synchronization detection angle θ_{BD} to be determined, the light amount of the light flux reaching the synchronous detection edge unit 80 and the synchronous detection unit 90 is somewhat increased.

That is, in the light scanning apparatus 1 according to the present embodiment, the spread of the diffracted light of the second or higher order in the cross section perpendicular to the optical axis is suppressed since the synchronous detection optical element 70 is arranged so as to face the optical axis of the synchronous detection optical system 95.

Thereby, it is possible to suppress a deterioration in the accuracy in determining the synchronization detection angle θ_{BD}, namely the synchronization detection accuracy.

In the light scanning apparatus 1 according to the present embodiment, the incident optical element 30 and the synchronous detection optical element 70 are provided as members separate from each other, and the scanning optical element 60 and the synchronous detection optical element 70 are provided as members separate from each other.

That is, in the light scanning apparatus 1 according to the present embodiment, an optical element integrated with the synchronous detection optical element 70 is not provided.

In other words, in the light scanning apparatus 1 according to the present embodiment, each of the incident light flux guided by the incident optical system 75 and the scanning light flux guided by the imaging optical system 85 does not pass through the synchronous detection optical element 70.

In still other words, in the light scanning apparatus 1 according to the present embodiment, the synchronous detection optical element 70 is not shared by each of the incident optical system 75 and the imaging optical system 85.

If the incident optical element 30 or the scanning optical element 60 and the synchronous detection optical element 70 are formed as an integral member by a single plastic mold lens, the molding difficulty increases, and the optical performance is likely to deteriorate.

In particular, as described above, it does not become easy to make the synchronous detection optical element 70 face the optical axis of the synchronous detection optical system 95 due to the structural restriction of the mold used to form the diffracting surface on the synchronous detection optical element 70 and the support and abutment of the synchronous detection optical element 70 on the housing.

In addition, since the synchronous detection optical element 70 has a long and complicated shape, unexpected birefringence or temperature distribution may formed inside the synchronous detection optical element 70 to cause deterioration in optical performance such as defocus or spot enlargement, which is difficult to control, which is not preferable.

In the light scanning apparatus 1 according to the present embodiment, when a total length of the synchronous detection optical system 95 is represented by D_{BD} and a scanned width of the surface to be scanned 100 is represented by h, it is preferred that the following Inequality (6) be satisfied:

$$0.14 \leq \frac{{D}_{BD}}{h} \leq 0.33 . \qquad ( 6 )$$

The total length of the synchronous detection optical system 95 means a distance between a deflection point on the deflecting surface 50a of the deflecting unit 50 with respect to a principal ray guided to an intersection between the optical axis of the synchronous detection optical system 95 and the light receiving surface of the synchronous detection unit 90 by the synchronous detection optical system 95 and the intersection.

Further, the scanned width of the surface 100 means a distance between one outermost off-axis image height and the other outermost off-axis image height on the surface 100.

If the total length of the synchronous detection optical system 95 increases such that the ratio exceeds the upper limit value in Inequality (6), the size of the light scanning apparatus 1 increases, which is not preferable.

On the other hand, if the ratio falls below the lower limit value in Inequality (6), the focal length of the synchronous detection optical element 70 in the main scanning cross section becomes too short, so that the depth width becomes narrow and the convenience deteriorates, which is not preferable.

In the light scanning apparatus 1 according to the present embodiment, it is more preferred that the following Inequality (6a) be satisfied instead of Inequality (6):

$$0.18 \leq \frac{{D}_{BD}}{h} \leq 0.33 . \qquad ( 6 a )$$

Since D_{BD}/h=63.54/214.00=0.30 in the light scanning apparatus 1 according to the present embodiment, Inequalities (6) and (6a) are satisfied.

Next, when a total length of the imaging optical system 85 is represented by T_{c}, it is preferred that the following Inequality (7) be satisfied in the light scanning apparatus 1 according to the present embodiment:

$$0.7 \leq \frac{h}{2 {T}_{c}} \leq 1.1 . \qquad ( 7 )$$

Here, the total length of the imaging optical system 85 means a distance between a deflection point on the deflecting surface 50a of the deflecting unit 50 with respect to the principal ray of the light flux scanning the on-axis image height of the surface 100 and the on-axis image height.

If the ratio exceeds the upper limit value in Inequality (7), a scanning angle of view becomes too large, which makes it difficult to arrange the synchronous detection optical system 95 between the incident optical system 75 and the imaging optical system 85, which is not preferable.

On the other hand, if the total length of the imaging optical system 85 increases such that the ratio falls below the lower limit value in Inequality (7), the size of the light scanning apparatus 1 is increased, which is not preferable.

In the light scanning apparatus 1 according to the present embodiment, it is more preferred that the following Inequality (7a) be satisfied instead of Inequality (7):

$$0.7 \leq \frac{h}{2 {T}_{c}} \leq 1. . \qquad ( 7 a )$$

In the light scanning apparatus 1 according to the present embodiment, since h/(2×T_{c})=214.00/(2×141.50)=0.76, Inequalities (7) and (7a) are satisfied.

Further, when focal lengths of the synchronous detection optical system 95 and the imaging optical system 85 in the main scanning cross section are represented by fₘ and fθ, respectively, it is preferred that the following Inequality (8) be satisfied in the light scanning apparatus 1 according to the present embodiment:

$$0.05 \leq \frac{{f}_{m}}{f θ} \leq 0.5 . \qquad ( 8 )$$

If the ratio exceeds the upper limit value in Inequality (8), the total length of the synchronous detection optical system 95 becomes too large, and the size of the light scanning apparatus 1 increases, which is not preferable.

On the other hand, if the focal length of the synchronous detection optical system 95 in the main scanning cross section becomes small such that the ratio falls below the lower limit value in Inequality (8), the depth width in the synchronous detection edge unit 80 becomes too narrow.

Therefore, the variation of the main scanning LSF spot diameter in the synchronous detection edge unit 80 due to the defocus caused by the variation of the environmental temperature becomes large.

In addition, the light flux diameter of the light flux in the main scanning direction when the light flux is received by the synchronous detection unit 90 increases, and thus it becomes difficult to obtain a sufficient signal intensity, which is not preferable.

In the light scanning apparatus 1 according to the present embodiment, it is more preferred that the following Inequality (8a) be satisfied instead of Inequality (8):

$$0.1 \leq \frac{{f}_{m}}{f θ} \leq 0.35 . \qquad ( 8 a )$$

Since fₘ/fθ=38.26/126.61=0.30 in the light scanning apparatus 1 according to the present embodiment, Inequalities (8) and (8a) are satisfied.

Further, when a focal length of the synchronous detection optical system 95 in the sub-scanning cross section is represented by fₛ, it is preferred that the following Inequality (9) be satisfied in the light scanning apparatus 1 according to the present embodiment:

$$0.2 \leq \frac{{f}_{s}}{{D}_{BD}} \leq 0.5 . \qquad ( 9 )$$

If the ratio exceeds the upper limit value in Inequality (9), the light flux diameter in the sub-scanning direction of the light flux when the light flux is received by the synchronous detection unit 90 increases, which makes it difficult to obtain a sufficient signal intensity, which is not preferable.

On the other hand, if the total length of the synchronous detection optical system 95 increases such that the ratio falls below the lower limit value in Inequality (9), the size of the light scanning apparatus 1 is increased, which is not preferable.

Further, if the focal length fₛ becomes small such that the ratio falls below the lower limit value in Inequality (9), the light flux deflected toward the synchronous detection unit 90 by the deflecting unit 50 at the second timing becomes condensed in the vicinity of the synchronous detection edge unit 80 even in the sub-scanning cross section, which is not preferable.

Alternatively, it becomes difficult to obtain a sufficient signal intensity in the synchronous detection unit 90 due to the light flux that has spread after being condensed once reaching the synchronous detection unit 90, which is not preferable.

In the light scanning apparatus 1 according to the present embodiment, it is more preferred that the following Inequality (9a) be satisfied instead of Inequality (9):

$$0.25 \leq \frac{{f}_{s}}{{D}_{BD}} \leq 0.5 . \qquad ( 9 a )$$

Since fₛ/D_{BD}=28.91/63.54=0.46 in the light scanning apparatus 1 according to the present embodiment, Inequalities (9) and (9a) are satisfied.

As described above, in the light scanning apparatus 1 according to the present embodiment, the diffracting surface is provided so as to satisfy Inequality (5) in the synchronous detection optical element 70.

Thereby, it is possible to provide a light scanning apparatus capable of suppressing a deterioration in synchronization detection accuracy due to a temperature variation even when the synchronous detection optical system 95 has a small size and a short total length.

In the light scanning apparatus 1 according to the present embodiment, a coupling lens and a cylindrical lens may be provided instead of the incident optical element 30.

In the light scanning apparatus 1 according to the present embodiment, the stop 40 and the synchronous detection edge unit 80 are formed integrally with the housing (not shown) that holds the respective optical elements, but the present invention is not limited thereto, and they may be provided as optical elements separate from the housing.

Further, in the light scanning apparatus 1 according to the present embodiment, the stop 40 for limiting the light flux diameter in each of the main scanning direction and the sub-scanning direction of the light flux that has passed through the incident optical element 30 is provided, but the present invention is not limited thereto.

That is, instead of the stop 40, a main scanning stop for limiting the light flux diameter in the main scanning direction and a sub-scanning stop for limiting the light flux diameter in the sub-scanning direction may be provided.

In the light scanning apparatus 1 according to the present embodiment, the deflecting unit 50 is formed by a polygon mirror. However, the present invention is not limited thereto, and the deflecting unit 50 may be formed by a vibration-type reflecting element such as a micro electromechanical systems (MEMS) mirror.

Further, the deflecting unit 50 may have a deflecting surface 50a in a shape of curved surface such as a spherical surface or a cylindrical surface, and the number of the deflecting surfaces 50a is not limited to four.

In the light scanning apparatus 1 according to the present embodiment, the imaging optical system 85 is formed by the single scanning optical element 60, but the present invention is not limited thereto, and the imaging optical system 85 may be formed by a plurality of optical elements such as lenses and mirrors.

In the light scanning apparatus 1 according to the present embodiment, the above-described structure is applied to the synchronous detection optical system 95 to suppress a deterioration in the synchronization detection accuracy due to a change in the environmental temperature, but the present invention is not limited thereto.

For example, the above-described structure may be applied to an auto power control (APC) optical system that guides a light flux to an APC sensor for causing a light emitting point of the light source 10 to emit light at a desired light amount, thereby suppressing a deterioration in light amount detection accuracy due to a change in environmental temperature.

Further, in the light scanning apparatus 1 according to the present embodiment, the incident surface of the synchronous detection optical element 70 is formed as a refracting surface on which a diffraction grating is not formed, and the exit surface thereof is formed as a diffracting surface on which the diffraction grating is formed on a flat surface, but the present invention is not limited thereto.

That is, the diffraction grating may be formed on a base surface in a shape of a curved surface on at least one of the incident surface and the exit surface of the synchronous detection optical element 70.

For such optical surface, the diffractive power and the refractive power may be separated from each other.

### Second Embodiment

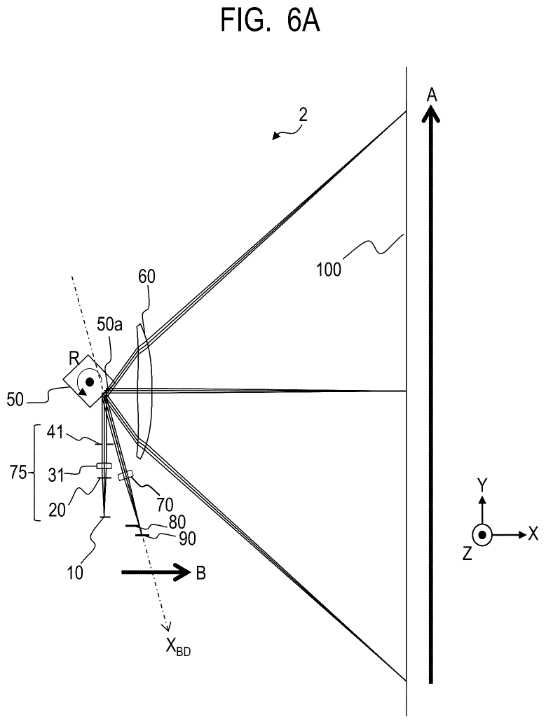

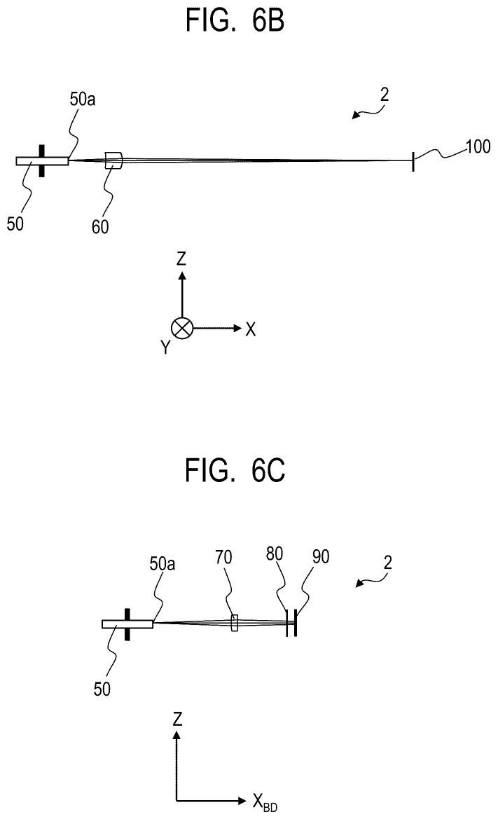

FIG. 6A shows a schematic main scanning cross sectional view of a light scanning apparatus 2 according to a second embodiment of the present invention.

FIGS. 6B and 6C show schematic sub-scanning cross sectional views of an imaging optical system 85 and a synchronous detection optical system 95 provided in the light scanning apparatus 2 according to the second embodiment, respectively.

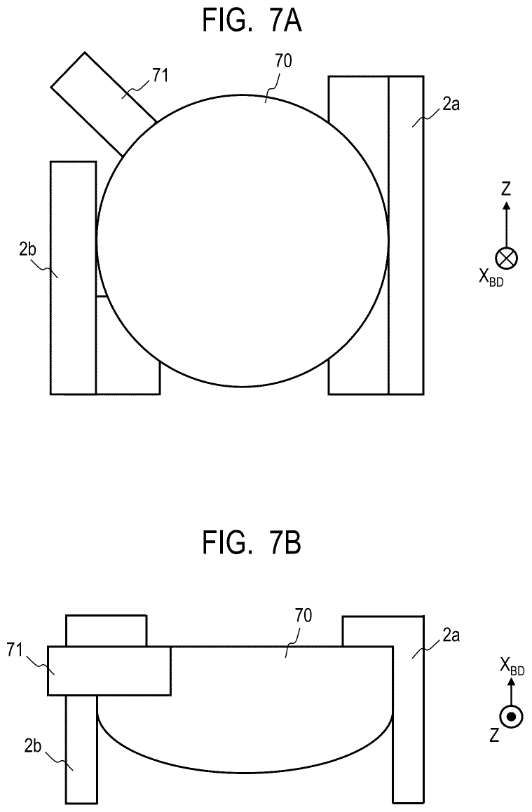

FIG. 7A and FIG. 7B show a schematic front view and a schematic top view of the synchronous detection optical element 70 provided in the light scanning apparatus 2 according to the second embodiment, respectively.

The light scanning apparatus 2 according to the present embodiment has the same structure as that of the light scanning apparatus 1 according to the first embodiment except that a sub-scanning stop 20 and a main scanning stop 41 are provided instead of the stop 40 and an incident optical element 31 is provided instead of the incident optical element 30. Therefore, the same members are denoted by the same reference numerals, and description thereof is omitted.

The light scanning apparatus 2 according to the present embodiment includes a light source 10, a sub-scanning stop 20, an incident optical element 31 (second optical element), a main scanning stop 41, a deflecting unit 50, a scanning optical element 60, a synchronous detection optical element 70, a synchronous detection edge unit 80, and a synchronous detection unit 90.

The sub-scanning stop 20 has a rectangular opening, and limits the light flux diameter of the light flux emitted from the light source 10 in the sub-scanning direction.

In the light scanning apparatus 2 according to this embodiment, the sub-scanning stop 20 is formed integrally with the housing (not shown).

The incident optical element 31 is an anamorphic lens having different positive powers in the main scanning cross section and the sub-scanning cross section.

The incident optical element 31 converts the light flux that has passed through the sub-scanning stop 20 into a parallel light flux in the main scanning cross section, and condenses the light flux in the vicinity of the deflecting surface 50a of the deflecting unit 50 in the sub-scanning cross section.

The parallel light flux includes not only a strictly parallel light flux but also a substantially parallel light flux such as a weakly divergent light flux or a weakly convergent light flux.

The main scanning stop 41 has a rectangular opening, and limits the light flux diameter in the main scanning direction of the light flux that has passed through the incident optical element 31.

In the light scanning apparatus 2 according to the present embodiment, the main scanning stop 41 is formed integrally with the housing (not shown).

The deflecting unit 50 is a polygon mirror (rotary polygon mirror) formed by mirror-finishing an aluminum metal and having four reflecting surfaces each having a planar shape.

The deflecting unit 50 deflects the light flux that has passed through the main scanning stop 41 with rotating in the direction of arrow R in FIG. 6A by the driving unit such as the motor (not shown).

The light flux emitted from the light source 10 passes through the sub-scanning stop 20, the incident optical element 31, and the main scanning stop 41, and is incident on the deflecting unit 50 such that a line image elongated in the main scanning direction is formed on the deflecting surface 50a.

In the light scanning apparatus 2 according to the present embodiment, unlike the light scanning apparatus 1 according to the first embodiment, the light flux emitted from the light source 10 travels from a negative side to a positive side in the Y direction to be incident on the deflecting unit 50.

Therefore, in the light scanning apparatus 2 according to the present embodiment, the deflecting unit 50 rotates in a direction opposite to that of the light scanning apparatus 1 according to the first embodiment, and thus the surface to be scanned 100 is scanned in a direction opposite to that of the first embodiment.

That is, since the deflecting unit 50 rotates in the opposite direction, in the light scanning apparatus 2 according to the present embodiment, relative arrangements of the supporting units 2a and 2b for supporting the synchronous detection optical element 70 and the gate portion 71 are different from those of the light scanning apparatus 1 according to the first embodiment as shown in FIG. 7A and FIG. 7B.

In the light scanning apparatus 2 according to the present embodiment, the incident optical system 75 is formed by the sub-scanning stop 20, the incident optical element 31 and the main scanning stop 41.

Further, the imaging optical system 85 is formed by the scanning optical element 60, and the synchronous detection optical system 95 is formed by the synchronous detection optical element 70 and the synchronous detection edge unit 80.

Next, specification values, a refractive index and coordinates of each optical surface, and a shape of each optical surface in the light scanning apparatus 2 according to the present embodiment are shown in the following Tables 4, 5 and 6, respectively.

As shown in Table 6, the shape (meridional line shape) in the main scanning cross section of each of the incident surface and the exit surface of the scanning optical element 60 provided in the light scanning apparatus 2 according to the present embodiment has an aspherical surface shape expressed by a polynomial function up to the tenth order.

Similarly, the curvature radius (curvature radius of sagittal line) r′ in the sub-scanning cross section at a position away from the optical axis by Y in the main scanning direction of each of the incident surface and the exit surface of the scanning optical element 60 provided in the light scanning apparatus 2 according to the present embodiment is expressed by a polynomial function up to the tenth order.

TABLE 4

| | Parameters | |
|---|---|---|
| Item | [Unit] | Value |
| Wavelength of light source 10 | λ[nm] | 790 |
| Width of surface to be scanned 100 | h[mm] | 214 |
| Number of deflecting surfaces 50a in deflecting unit 50 | [Surfaces] | 4 |
| Circumscribed diameter of deflecting unit 50 | Pd[mm] | 20 |
| Coordinates of rotation center of deflecting unit 50 | (X, Y)[mm] | (−5.89, 4.11) |
| Width in main scanning direction of opening formed in | Am[mm] | 1.80 |
| main scanning stop 41 | | |
| Width in sub-scanning direction of opening formed | As[mm] | 1.40 |
| in sub-scanning stop 20 | | |
| Total length of imaging optical system 85 | Tc[mm] | 125.00 |
| Focal length of imaging optical system 85 in main | fθ[mm] | 109.47 |
| scanning cross section | | |
| Total length of synchronous detection optical system 95 | D_BD[mm] | 53.38 |
| Focal length of synchronous detection optical element | fm[mm] | 19.31 |
| 70 in main scanning cross section | | |
| Focal length of synchronous detection optical element | fs[mm] | 19.31 |
| 70 in sub-scanning cross section | | |
| Focal length in main scanning cross section of diffractive | fdm[mm] | 29.07 |
| component of synchronous detection optical element 70 | | |
| Focal length in main scanning cross section of refractive | frm[mm] | 54.43 |
| component of synchronous detection optical element 70 | | |

TABLE 5

| | Refractive | Coordinates of surface | | | Direction cosine of | | |
|---|---|---|---|---|---|---|---|
| | index | vertex (center) | | | optical axis | | |
| Optical surface | (λ = 793 nm) | tc(x) | tc(y) | tc(z) | gx(x) | gx(y) | gx(z) |
| Light emission point of light source 10 | — | 0.00 | −46.50 | 0.00 | 0.00 | −1.00 | 0.00 |
| Sub-scanning stop 20 | — | 0.00 | −32.39 | 0.00 | 0.00 | −1.00 | 0.00 |
| Incident surface of incident optical | 1.53 | 0.00 | −28.67 | 0.00 | 0.00 | −1.00 | 0.00 |
| element 31 | | | | | | | |
| Exit surface of incident optical element | — | 0.00 | −26.67 | 0.00 | 0.00 | −1.00 | 0.00 |
| 31 | | | | | | | |
| Main scanning stop 41 | — | 0.00 | −19.79 | 0.00 | 0.00 | −1.00 | 0.00 |
| Deflecting surface 50a of deflecting | — | −0.89 | −0.89 | 0.00 | 0.71 | −0.71 | 0.00 |
| unit 50 | | | | | | | |
| (when on-axis image height is scanned) | | | | | | | |
| Incident surface of scanning optical | 1.53 | 13.80 | −0.18 | 0.00 | 1.00 | 0.00 | 0.00 |
| element 60 | | | | | | | |
| Exit surface of scanning optical | — | 19.80 | −0.18 | 0.00 | 1.00 | 0.00 | 0.00 |
| element 60 | | | | | | | |
| Incident surface of synchronous | 1.53 | 8.51 | −30.03 | 0.00 | 0.29 | −0.96 | 0.00 |
| detection optical element 70 | | | | | | | |
| Exit surface of synchronous detection | — | 9.21 | −32.32 | 0.00 | 0.29 | −0.96 | 0.00 |
| optical element 70 | | | | | | | |
| Synchronous detection edge unit 80 | — | 14.57 | −49.89 | 0.00 | 0.00 | −1.00 | 0.00 |
| Synchronous detection unit 90 | — | 15.51 | −52.94 | 0.00 | 0.00 | −1.00 | 0.00 |
| Surface to be scanned 100 | — | 125.00 | −0.18 | 0.00 | 1.00 | 0.00 | 0.00 |

TABLE 6

| | Aspherical surface coefficient | | | | | | |
|---|---|---|---|---|---|---|---|
| | | Incident optical | | Scanning optical | | Synchronous detection | |
| | | element 31 | | element 60 | | optical element 70 | |
| | | Incident | Exit | Incident | Exit | Incident | Exit |
| | Coefficient | surface | surface | surface | surface | surface | surface |
| Meridional | R | — | −4.15E+01 | 9.83E+01 | −1.77E+02 | 2.87E+01 | — |
| line | K | — | — | −1.12E+01 | 4.17E+01 | — | — |
| | B1 | — | — | — | — | — | — |
| | B2u | — | — | — | — | — | — |
| | B2l | — | — | — | — | — | — |
| | B3 | — | — | −2.77E−06 | −1.25E−05 | — | — |
| | B4u | — | — | −2.38E−05 | −9.75E−06 | — | — |
| | B4l | — | — | −2.31E−05 | −1.05E−05 | — | — |
| | B5 | — | — | — | — | — | — |
| | B6u | — | — | 4.59E−08 | 5.13E−10 | — | — |
| | B6l | — | — | 4.55E−08 | 7.36E−10 | — | — |
| | B7 | — | — | — | — | — | — |
| | B8u | — | — | −4.20E−11 | 1.74E−11 | — | — |
| | B8l | — | — | −4.55E−11 | 2.08E−11 | — | — |
| | B9 | — | — | — | — | — | — |
| | B10u | — | — | 1.43E−14 | −1.03E−14 | — | — |
| | B10l | — | — | 1.50E−14 | −1.90E−14 | — | — |
| Sagittal | r | — | −1.24E+01 | −2.52E+01 | −6.94E+00 | 2.87E+01 | — |
| line | E1 | — | — | 1.34E−03 | 7.45E−04 | — | — |
| | E2u | — | — | −4.07E−06 | 1.62E−04 | — | — |
| | E2l | — | — | −4.07E−06 | 1.62E−04 | — | — |
| | E3 | — | — | −1.13E−06 | 7.71E−07 | — | — |
| | E4u | — | — | 1.52E−07 | −6.18E−07 | — | — |
| | E4l | — | — | 1.52E−07 | −6.18E−07 | — | — |
| | E5 | — | — | −1.44E−09 | −9.83E−10 | — | — |
| | E6u | — | — | −3.84E−10 | 1.26E−09 | — | — |
| | E6l | — | — | −3.84E−10 | 1.26E−09 | — | — |
| | E7 | — | — | 2.81E−12 | −1.83E−12 | — | — |
| | E8u | — | — | −1.57E−14 | −1.24E−12 | — | — |
| | E8l | — | — | −1.57E−14 | −1.24E−12 | — | — |
| | E9 | — | — | — | 5.25E−15 | — | — |
| | E10u | — | — | — | 1.74E−18 | — | — |
| | E10l | — | — | — | 1.74E−18 | — | — |
| Phase | C2 | — | — | — | — | — | −1.72E−02 |
| coefficient | C3 | −2.59E−02 | — | — | — | — | — |
| | C5 | −2.22E−02 | — | — | — | — | — |

An incident surface of the incident optical element 31 provided in the light scanning apparatus 2 according to the present embodiment is a diffracting surface on which a diffraction grating is formed.

Specifically, the incident surface of the incident optical element 31 is formed as a diffracting surface defined by a phase function φ expressed by the following Expression (10):

$$ϕ = \frac{2 π M}{λ} ( {C}_{3} {Z}^{2} \times {C}_{5} {Y}^{2} ) . \qquad ( 10 )$$

In Expression (10), M represents the diffraction order, and since first order diffracted light is used in the light scanning apparatus 2 according to the present embodiment, the diffraction order M is 1.

That is, the diffraction order M of the incident surface of the incident optical element 31 is the same as that of the exit surface of the synchronous detection optical element 70.

In Expression (10), λ represents the wavelength (design wavelength) of the light flux emitted from the light source 10, specifically, is 790 nm.

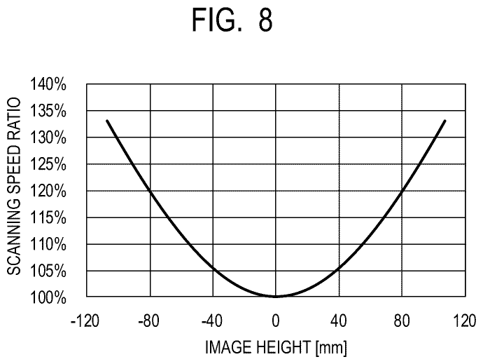

FIG. 8 shows an image height dependence of a scanning speed ratio in the light scanning apparatus 2 according to the present embodiment.

The term “scanning speed ratio” as used herein refers to a ratio of the scanning speed at each image height to that at the on-axis image height (Y=0 mm) on the surface to be scanned 100, namely the scanning speed ratio at the on-axis image height is 100%.

As shown in FIG. 8, the light scanning apparatus 2 according to the present embodiment has a non-uniform speed scanning characteristic having a profile expressed by a quadratic function such that the scanning speed ratio at the outermost off-axis image heights (Y=±107 mm) becomes about 133%.

That is, in the light scanning apparatus 2 according to the present embodiment, the surface 100 is optically scanned at a non-constant speed by the light flux deflected by the deflecting unit 50 rotating at a constant speed.

In other words, in the light scanning apparatus 2 according to the present embodiment, the imaging optical system 85 is configured such that a partial magnification in the main scanning direction is different between the on-axis image height and the outermost off-axis image heights.

Such structure is advantageous in shortening the optical path since distortion can be substantially allowed as compared with a typical light scanning apparatus having a constant-speed scanning characteristic using a so-called fθ lens.

In particular, the light scanning apparatus 2 according to the present embodiment in which the total length of the imaging optical system 85 formed by the single scanning optical element 60 is short can have the non-uniform speed scanning characteristic to achieve downsizing with maintaining high optical performance.

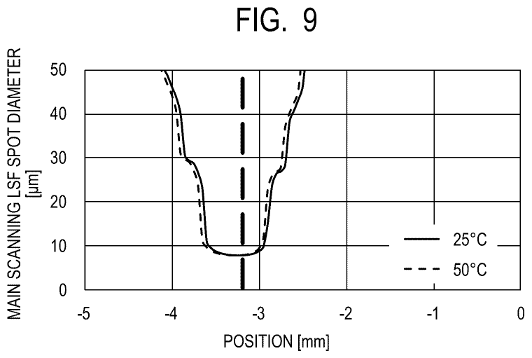

FIG. 9 shows a variation in the main scanning LSF spot diameter with respect to a variation in the position in the direction parallel to the optical axis of the synchronous detection optical system 95 in the light scanning apparatus 2 according to the present embodiment corresponding to FIG. 4B described above, namely a defocus characteristic of the main scanning LSF spot diameter.

As for the position in the direction parallel to the optical axis of the synchronous detection optical system 95 on the horizontal axis of FIG. 9, 0 mm corresponds to the position of the synchronous detection unit 90, and −3.19 mm corresponds to the position of the synchronous detection edge unit 80.

When FIG. 9 is compared with FIG. 4B, in the light scanning apparatus 2 according to the present embodiment, the focal length of the synchronous detection optical system 95 is shorter than that of the light scanning apparatus 1 according to the first embodiment, so that the depth width is narrower as a whole.

In addition, compared to the light scanning apparatus 1 according to the first embodiment, a variation amount in focus when the environmental temperature varies is reduced.

Therefore, even when the environmental temperature increases from 25° C. to 50° C., the main scanning LSF spot diameter at the position of the synchronous detection edge unit 80 hardly changes, namely the increase in the main scanning LSF spot diameter can be suppressed.

This is because, in the light scanning apparatus 2 according to the present embodiment, the incident optical element 31 in which the diffraction grating is formed on the incident surface is used instead of the incident optical element 30 in addition to the synchronous detection optical element 70.

Further, since f_{dm}/fᵣₘ=29.07/54.43=0.53, Inequalities (5), (5a) and (5b) are satisfied in the light scanning apparatus 2 according to the present embodiment.

Since D_{BD}/h=53.38/214.00=0.25, Inequalities (6) and (6a) are satisfied in the light scanning apparatus 2 according to the present embodiment.

Since h/(2×T_{c})=214.00/(2×125.00)=0.86, Inequalities (7) and (7a) are satisfied in the light scanning apparatus 2 according to the present embodiment.

Since fₘ/fθ=19.31/109.47=0.18, Inequalities (8) and (8a) are satisfied in the light scanning apparatus 2 according to the present embodiment.

Since the fₛ/D_{BD}=19.31/53.38=0.36, Inequalities (9) and (9a) are satisfied in the light scanning apparatus 2 according to the present embodiment.

As described above, in the light scanning apparatus 2 according to the present embodiment, the diffractive surface is provided so as to satisfy Inequality (5) in the synchronous detection optical element 70.

Thereby, it is possible to provide a light scanning apparatus capable of suppressing a deterioration in synchronization detection accuracy due to a temperature variation even when the synchronous detection optical system 95 has a small size and a short total length.

In the light scanning apparatus 2 according to the present embodiment, the sub-scanning stop 20 and the main scanning stop 41 are formed integrally with the housing (not shown) that holds respective optical elements, but the present invention is not limited thereto, and they may be provided as optical elements separate from the housing.

Further, in the light scanning apparatus 2 according to the present embodiment, both of the incident surface and the exit surface of the incident optical element 31 may be diffracting surfaces, in other words, at least one of the incident surface and the exit surface of the incident optical element 31 may be a diffracting surface.

### Third Embodiment

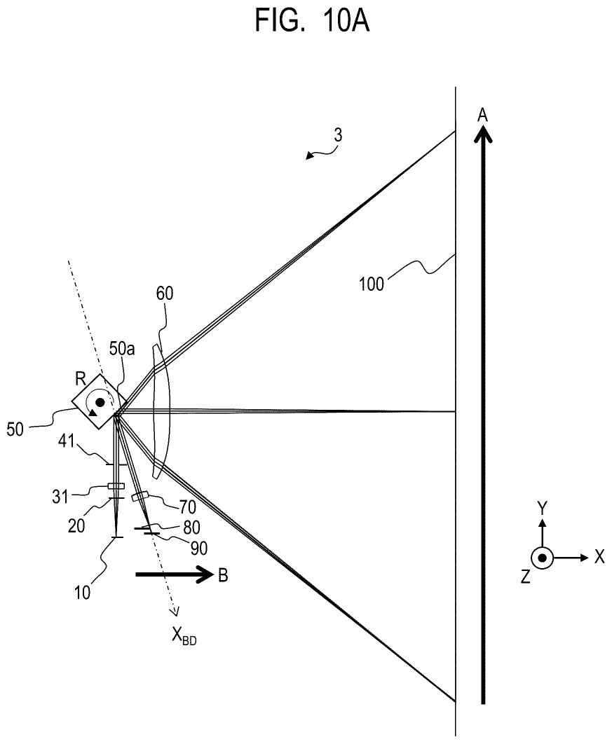

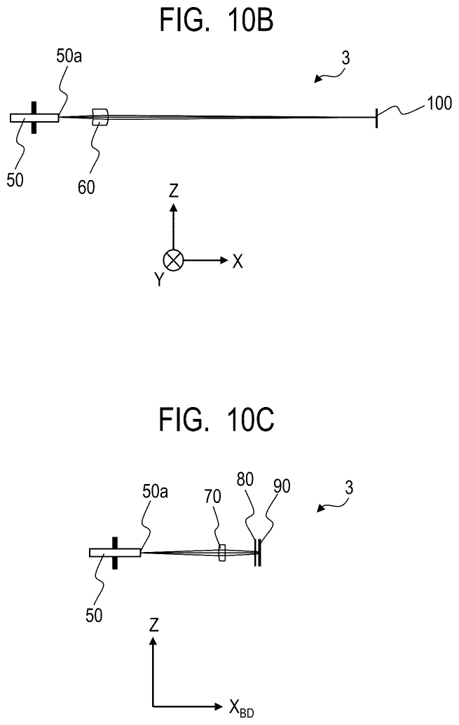

FIG. 10A shows a schematic main scanning cross sectional view of a light scanning apparatus 3 according to a third embodiment of the present invention.

FIG. 10B and FIG. 10C show schematic sub-scanning cross sectional views of the imaging optical system 85 and the synchronous detection optical system 95 provided in the light scanning apparatus 3 according to the third embodiment, respectively.

The light scanning apparatus 3 according to the present embodiment has the same structure as that of the light scanning apparatus 2 according to the second embodiment except that the specification values are different, so that the same members are denoted by the same reference numerals, and the description thereof is omitted.

Specifically, in the light scanning apparatus 3 according to the present embodiment, an interval between the synchronous detection optical element 70 and the synchronous detection edge unit 80 is shortened by using the synchronous detection optical element 70 having a shorter focal length in the main scanning cross section than that of the light scanning apparatus 2 according to the second embodiment. Thereby, the optical path of the synchronous detection optical system 95 is shortened.

Further, specification values, a refractive index and coordinates of each optical surface, and a shape of each optical surface in the light scanning apparatus 3 according to the present embodiment are shown in the following Tables 7, 8 and 9, respectively.

TABLE 7

| | Parameter | |
|---|---|---|
| Item | [Unit] | Value |
| Wavelength of light source 10 | λ[nm] | 790 |
| Width of surface to be scanned 100 | h[mm] | 214 |
| Number of deflecting surfaces 50a in deflecting unit 50 | [Surfaces] | 4 |
| Circumscribed diameter of deflecting unit 50 | Pd[mm] | 20 |
| Coordinates of rotation center of deflecting unit 50 | (X, Y)[mm] | (−5.89, 4.11) |
| Width in main scanning direction of opening formed in | Am[mm] | 1.80 |
| main scanning stop 41 | | |
| Width in sub-scanning direction of opening formed in | As[mm] | 1.40 |
| sub-scanning stop 20 | | |
| Total length of imaging optical system 85 | Tc[mm] | 125.00 |
| Focal length of imaging optical system 85 in main | fθ[mm] | 109.47 |
| scanning cross section | | |
| Total length of synchronous detection optical system 95 | D_BD[mm] | 44.19 |
| Focal length of synchronous detection optical element | fm[mm] | 12.27 |
| 70 in main scanning cross section | | |
| Focal length of synchronous detection optical element | fs[mm] | 12.27 |
| 70 in sub-scanning cross section | | |
| Focal length in main scanning cross section of diffractive | fdm[mm] | 20.41 |
| component of synchronous detection optical element 70 | | |
| Focal length in main scanning cross section of refractive | frm[mm] | 28.40 |
| component of synchronous detection optical element 70 | | |

TABLE 8

| | Refractive | Coordinates of surface | | | Direction cosine of | | |
|---|---|---|---|---|---|---|---|
| | index | vertex (center) | | | optical axis | | |
| Optical surface | (λ = 793 nm) | tc(x) | tc(y) | tc(z) | gx(x) | gx(y) | gx(z) |
| Light emission point of light source 10 | — | 0.00 | −46.50 | 0.00 | 0.00 | −1.00 | 0.00 |
| Sub-scanning stop 20 | — | 0.00 | −32.39 | 0.00 | 0.00 | −1.00 | 0.00 |
| Incident surface of incident optical element 31 | 1.53 | 0.00 | −28.67 | 0.00 | 0.00 | −1.00 | 0.00 |
| Exit surface of incident optical element 31 | — | 0.00 | −26.67 | 0.00 | 0.00 | −1.00 | 0.00 |
| Main scanning stop 41 | — | 0.00 | −19.79 | 0.00 | 0.00 | −1.00 | 0.00 |
| Deflecting surface 50a of deflecting unit 50 | — | −0.89 | −0.89 | 0.00 | 0.71 | −0.71 | 0.00 |
| (when on-axis image height is scanned) | | | | | | | |
| Incident surface of scanning optical element 60 | 1.53 | 13.80 | −0.18 | 0.00 | 1.00 | 0.00 | 0.00 |
| Exit surface of scanning optical element 60 | — | 19.80 | −0.18 | 0.00 | 1.00 | 0.00 | 0.00 |
| Incident surface of synchronous detection | 1.53 | 8.46 | −29.88 | 0.00 | 0.29 | −0.96 | 0.00 |
| optical element 70 | | | | | | | |
| Exit surface of synchronous detection optical | — | 9.16 | −32.17 | 0.00 | 0.29 | −0.96 | 0.00 |
| element 70 | | | | | | | |
| Synchronous detection edge unit 80 | — | 12.48 | −43.04 | 0.00 | 0.00 | −1.00 | 0.00 |
| Synchronous detection unit 90 | — | 12.91 | −44.43 | 0.00 | 0.29 | −0.96 | 0.00 |
| Surface to be scanned 100 | — | 125.00 | −0.18 | 0.00 | 1.00 | 0.00 | 0.00 |

TABLE 9

| | Aspherical surface coefficient | | | | | | |
|---|---|---|---|---|---|---|---|
| | | Incident optical | | Scanning optical | | Synchronous detection | |
| | | element 31 | | element 60 | | optical element 70 | |
| | | Incident | Exit | Incident | | Incident | Exit |
| | Coefficient | surface | surface | surface | Exit surface | surface | surface |
| Meridional | R | — | −4.15E+01 | 9.83E+01 | −1.77E+02 | 1.50E+01 | — |
| line | K | — | — | −1.12E+01 | 4.17E+01 | — | — |
| | B1 | — | — | — | — | — | — |
| | B2u | — | — | — | — | — | — |
| | B2l | — | — | — | — | — | — |
| | B3 | — | — | −2.77E−06 | −1.25E−05 | — | — |
| | B4u | — | — | −2.38E−05 | −9.75E−06 | — | — |
| | B4l | — | — | −2.31E−05 | −1.05E−05 | — | — |
| | B5 | — | — | — | — | — | — |
| | B6u | — | — | 4.59E−08 | 5.13E−10 | — | — |
| | B6l | — | — | 4.55E−08 | 7.36E−10 | — | — |
| | B7 | — | — | — | — | — | — |
| | B8u | — | — | −4.20E−11 | 1.74E−11 | — | — |
| | B8l | — | — | −4.55E−11 | 2.08E−11 | — | — |
| | B9 | — | — | — | — | — | — |
| | B10u | — | — | 1.43E−14 | −1.03E−14 | — | — |
| | B10l | — | — | 1.50E−14 | −1.90E−14 | — | — |
| Sagittal | r | — | −1.24E+01 | −2.52E+01 | −6.94E+00 | 1.50E+01 | — |
| line | E1 | — | — | 1.34E−03 | 7.45E−04 | — | — |
| | E2u | — | — | −4.07E−06 | 1.62E−04 | — | — |
| | E2l | — | — | −4.07E−06 | 1.62E−04 | — | — |
| | E3 | — | — | −1.13E−06 | 7.71E−07 | — | — |
| | E4u | — | — | 1.52E−07 | −6.18E−07 | — | — |
| | E4l | — | — | 1.52E−07 | −6.18E−07 | — | — |
| | E5 | — | — | −1.44E−09 | −9.83E−10 | — | — |
| | E6u | — | — | −3.84E−10 | 1.26E−09 | — | — |
| | E6l | — | — | −3.84E−10 | 1.26E−09 | — | — |
| | E7 | — | — | 2.81E−12 | −1.83E−12 | — | — |
| | E8u | — | — | −1.57E−14 | −1.24E−12 | — | — |
| | E8l | — | — | −1.57E−14 | −1.24E−12 | — | — |
| | E9 | — | — | — | 5.25E−15 | — | — |
| | E10u | — | — | — | 1.74E−18 | — | — |
| | E10l | — | — | — | 1.74E−18 | — | — |
| Phase | C2 | — | — | — | — | — | −2.45E−02 |
| coefficient | C3 | −2.59E−02 | — | — | — | — | — |
| | C5 | −2.22E−02 | — | — | — | — | — |

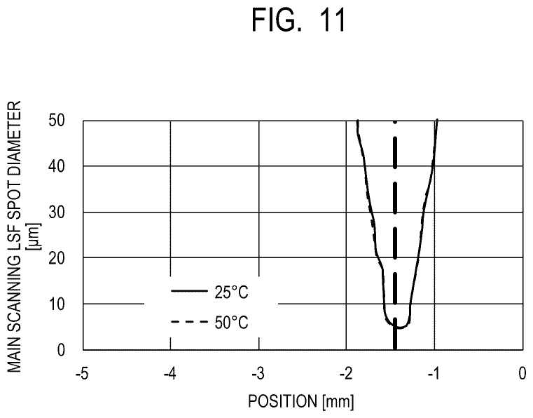

FIG. 11 shows a variation in the main scanning LSF spot diameter with respect to a variation in the position in the direction parallel to the optical axis of the synchronous detection optical system 95 in the light scanning apparatus 3 according to the present embodiment corresponding to FIGS. 4B and 9 described above, namely a defocus characteristic of the main scanning LSF spot diameter.

As for the position in the direction parallel to the optical axis of the synchronous detection optical system 95 on the horizontal axis of FIG. 11, 0 mm corresponds to the position of the synchronous detection unit 90, and −1.45 mm corresponds to the position of the synchronous detection edge unit 80.

When FIGS. 9 and 11 are compared with each other, in the light scanning apparatus 3 according to the present embodiment, the focal length of the synchronous detection optical system 95 is further shorter than that of the light scanning apparatus 2 according to the second embodiment, so that the depth width is further narrowed.

In addition, similarly to the light scanning apparatus 2 according to the second embodiment, the variation amount of the focus when the environmental temperature varies is reduced.

Therefore, even when the environmental temperature increases from 25° C. to 50° C., the main scanning LSF spot diameter at the position of the synchronous detection edge unit 80 hardly changes, namely an increase in the main scanning LSF spot diameter can be suppressed.

Further, since f_{dm}/fᵣₘ=20.41/28.40=0.72, Inequalities (5), (5a) and (5b) are satisfied in the light scanning apparatus 3 according to the present embodiment.

Since D_{BD}/h=44.19/214.00=0.21, Inequalities (6) and (6a) are satisfied in the light scanning apparatus 3 according to the present embodiment.

Since h/(2×T_{c})=214.00/(2×125.00)=0.86, Inequalities (7) and (7a) are satisfied in the light scanning apparatus 3 according to the present embodiment.

Since fₘ/fθ=12.27/109.47=0.11, Inequalities (8) and (8a) are satisfied in the light scanning apparatus 3 according to the present embodiment.

Since fₛ/D_{BD}=12.27/44.19=0.28, Inequalities (9) and (9a) are satisfied in the light scanning apparatus 3 according to the present embodiment.

As described above, in the light scanning apparatus 3 according to the present embodiment, the diffractive surface is provided so as to satisfy Inequality (5) in the synchronous detection optical element 70.

Thereby, it is possible to provide a light scanning apparatus capable of suppressing a deterioration in synchronization detection accuracy due to a temperature change even when the synchronous detection optical system 95 has a small size and a short total length.

Values corresponding to respective conditional expressions in each of the light scanning apparatuses according to the first to third embodiments are shown in the following Table 10.

TABLE 10

| | First | Second | Third |
|---|---|---|---|
| | embodiment | embodiment | embodiment |
| Inequality (5): 0 < fdm/frm ≤ 1.00 | 0.31 | 0.53 | 0.72 |
| Inequality (5a): 0.10 ≤ fdm/frm ≤ 0.90 | | | |
| Inequality (5b): 0.20 ≤ fdm/frm ≤ 0.80 | | | |
| Inequality (6): 0.14 ≤ D_BD/h ≤ 0.33 | 0.30 | 0.25 | 0.21 |
| Inequality (6a): 0.18 ≤ D_BD/h ≤ 0.33 | | | |
| Inequality (7): 0.70 ≤ h/2Tc ≤ 1.10 | 0.76 | 0.86 | 0.86 |
| Inequality (7a): 0.70 ≤ h/2Tc ≤ 1.00 | | | |
| Inequality (8): 0.05 ≤ fm/fθ ≤ 0.50 | 0.30 | 0.18 | 0.11 |
| Inequality (8a): 0.10 ≤ fm/fθ ≤ 0.35 | | | |
| Inequality (9): 0.20 ≤ fs/D_BD ≤ 0.50 | 0.46 | 0.36 | 0.28 |
| Inequality (9a): 0.25 ≤ fs/D_BD ≤ 0.50 | | | |

According to the present disclosure, a compact light scanning apparatus capable of suppressing a change in optical performance of an optical system due to a change in environmental temperature can be provided.

### [Image Forming Apparatus]

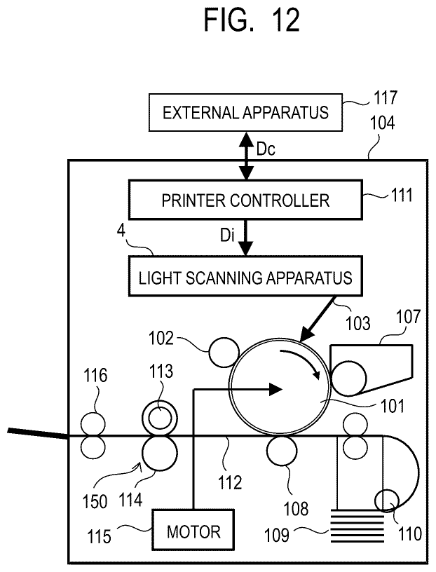

FIG. 12 shows a sub-scanning cross sectional view of a main part of an image forming apparatus 104 including a light scanning apparatus 4 according to any one of the first to third embodiments of the present invention.

As shown in FIG. 12, code data Dc output from an external apparatus 117 such as a personal computer is input to the image forming apparatus 104.

The input code data Dc is converted into image data (dot data) Di by a printer controller 111 provided in the image forming apparatus 104.

Next, the converted image data Di is input to the light scanning apparatus 4 according to any one of the first to third embodiments of the present invention.

A light beam 103 modulated in accordance with the image data Di is emitted from the light scanning apparatus 4, and a photosensitive surface of a photosensitive drum 101 is scanned in the main scanning direction by the light beam 103.

The photosensitive drum 101 as an electrostatic latent image bearing body (photosensitive body) is rotated clockwise as shown in FIG. 12 by a motor 115.

With this rotation, the photosensitive surface of the photosensitive drum 101 moves in the sub-scanning direction orthogonal to the main scanning direction with respect to the light beam 103.

Above the photosensitive drum 101, a charging roller 102 for uniformly charging the surface of the photosensitive drum 101 is provided so as to abut on the surface.

The surface of the photosensitive drum 101 charged by the charging roller 102 is irradiated with the light beam 103 scanned by the light scanning apparatus 4.

As described above, the light beam 103 is modulated based on the image data Di, and an electrostatic latent image is formed on the surface of the photosensitive drum 101 by irradiation with the light beam 103.

Then, the formed electrostatic latent image is developed as a toner image by a developing unit 107 arranged so as to abut on the photosensitive drum 101 further on a downstream side in the rotation direction from the irradiation position of the light beam 103 on the photosensitive drum 101.

Next, the toner image developed by the developing unit 107 is transferred onto a sheet 112 serving as a transferred material by a transferring roller 108 (transferring unit) arranged below the photosensitive drum 101 so as to face the photosensitive drum 101.

Note that the sheet 112 is stored in a sheet cassette 109 in front of the photosensitive drum 101 (on a right side in FIG. 12), but may be manually fed.

A sheet feeding roller 110 is arranged at an end of the sheet cassette 109, and the sheet 112 in the sheet cassette 109 is fed to a conveyance path.

The sheet 112 onto which the unfixed toner image has been transferred as described above is conveyed to a fixing unit 150 arranged behind the photosensitive drum 101 (on a left side in FIG. 12).

The fixing unit 150 includes a fixing roller 113 having a fixing heater therein, and a pressurizing roller 114 arranged so as to be in pressure contact with the fixing roller 113.

Then, the sheet 112 conveyed from the transferring roller 108 is heated with being pressed by a pressure contact portion between the fixing roller 113 and the pressurizing roller 114, thereby the unfixed toner image on the sheet 112 is fixed.

A sheet discharging roller 116 is arranged behind the fixing unit 150, and the sheet 112 on which the toner image has been fixed is discharged to an outside of the image forming apparatus 104.

Although not shown in FIG. 12, the printer controller 111 also controls each member in the image forming apparatus 104 such as the motor 115, a polygon motor in the light scanning apparatus 4 or the like in addition to the above-described data conversion.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-104569, filed Jun. 28, 2024, which is hereby incorporated by reference herein in its entirety.

What is claimed is:

1. A light scanning apparatus comprising:
a deflecting unit configured to deflect a light flux from a light source to scan a surface in a main scanning direction;
a first optical system configured to guide the light flux deflected by the deflecting unit to the surface to be scanned at a first timing; and
a second optical system configured to guide the light flux deflected by the deflecting unit to a light receiving element at a second timing different from the first timing,
wherein the second optical system includes a first optical element which has a diffracting surface and is configured to condense the light flux deflected by the deflecting unit at the second timing in a main scanning cross section, and
wherein a value of a diffractive power of the first optical element is equal to or larger than a value of a refractive power of the first optical element in the main scanning cross section.

2. The light scanning apparatus according to claim 1, wherein the following inequality is satisfied:
$$0.14 \leq \frac{{D}_{BD}}{h} \leq 0.33$$
where D_{BD} represents a total length of the second optical system, and h represents a scanned width on the surface to be scanned.

3. The light scanning apparatus according to claim 1, wherein the following inequality is satisfied:
$$0.7 \leq \frac{h}{2 {T}_{c}} \leq 1.1$$
where T_{c} represents a total length of the first optical system, and h represents a scanned width on the surface to be scanned.

4. The light scanning apparatus according to claim 1, wherein the following inequality is satisfied:
$$0.05 \leq \frac{{f}_{m}}{f θ} \leq 0.5$$
where fₘ and fθ represent focal lengths of the second optical system and the first optical system in the main scanning cross section, respectively.

5. The light scanning apparatus according to claim 1, wherein the following inequality is satisfied:
$$0.2 \leq \frac{{f}_{s}}{{D}_{BD}} \leq 0.5$$
where D_{BD} represents a total length of the second optical system, and fₛ represents a focal length of the second optical system in a sub-scanning cross section.

6. The light scanning apparatus according to claim 1, wherein the first optical element has a positive power in a sub-scanning cross section.

7. The light scanning apparatus according to claim 1, wherein the first optical element has a positive diffractive power in a sub-scanning cross section.

8. The light scanning apparatus according to claim 1, wherein the second optical system is not provided with an optical element having a refracting surface or a diffracting surface other than the first optical element.

9. The light scanning apparatus according to claim 1, wherein one of an incident surface and an exit surface of the first optical element has a shape in which a diffraction grating is formed on a flat surface, and the other has a curved shape in which the diffraction grating is not formed.

10. The light scanning apparatus according to claim 1,
wherein an exit surface of the first optical element has a shape in which a diffraction grating is formed on a flat surface, and
wherein an incident surface of the first optical element has a curved shape in which the diffraction grating is not formed.

11. The light scanning apparatus according to claim 1, wherein the first optical system does not include an imaging optical element integrated with the first optical element.

12. The light scanning apparatus according to claim 1, wherein the second optical system includes a light shielding member configured to shield a part of a plurality of light fluxes guided to respective positions in the main scanning direction on a light receiving surface of the light receiving element by the first optical element.

13. The light scanning apparatus according to claim 12, wherein in the main scanning cross section, the light shielding member extends in a direction non-parallel to an optical axis of the second optical system, and a predetermined corner portion of the light shielding member is arranged at a predetermined position on the optical axis of the second optical system.

14. The light scanning apparatus according to claim 13, wherein the light flux deflected by the deflecting unit at the second timing is condensed at the predetermined position by the first optical element in the main scanning cross section when a temperature of the light scanning apparatus is a predetermined temperature.

15. The light scanning apparatus according to claim 1, wherein an optical axis of the second optical system passes through a vertex of each of an incident surface and an exit surface of the first optical element.

16. The light scanning apparatus according to claim 1, further comprising:
the light receiving element; and
a controller configured to control a writing start timing on the surface to be scanned based on a signal from the light receiving element.

17. The light scanning apparatus according to claim 1, further comprising an incident optical system which includes a second optical element of which at least one of an incident surface and an exit surface is a diffracting surface and is configured to guide the light flux from the light source to the deflecting unit.

18. The light scanning apparatus according to claim 1, wherein the first optical system is configured such that a partial magnification in the main scanning direction is different between an on-axis image height and an outermost off-axis image height.

19. An image forming apparatus comprising:
the light scanning apparatus according to claim 1; and
a developing unit configured to develop an electrostatic latent image formed on the surface to be scanned by the light scanning apparatus.

20. An image forming apparatus comprising:
the light scanning apparatus according to claim 1; and
a controller configured to convert a signal output from an external apparatus into image data and input the image data to the light scanning apparatus.
